(19) United States
(12) Patent Application Publication
(10) Pub. No.: US 2026/0268307 A1
(43) Pub. Date: Sep. 10, 2026

(54) METHOD AND SYSTEM FOR PROVIDING NFT-BASED DIGITAL ITEMS

(71) Applicant: WEVERSE COMPANY INC., Seongnam-si, Gyeonggi-do (KR)

(72) Inventor: Sang Il SIM, Seongnam-si, Gyeonggi-do (KR)

(73) Assignee: WEVERSE COMPANY INC., Seongnam-si, Gyeonggi-do (KR)

(21) Appl. No.: 18/873,260

(22) PCT Filed: Jun. 8, 2023
(86) PCT No.: PCT/KR2023/007882

§ 371 Date: Dec. 9, 2024

(30) Foreign Application Priority Data
Jun. 9, 2022 (KR) 10-2022-0070357

(51) Int. Cl. G06Q 20/36

(52) U.S. Cl. CPC G06Q 20/367

(57) ABSTRACT

A method for providing non-fungible token (NFT)-based digital items involves generating NFTs through quizzes, with difficulty levels tailored to the rarity of synthesized items. Users can synthesize multiple digital items to acquire a new NFT, with attributes such as grade and target artist determined based on the input items.

### TECHNICAL FIELD

The present disclosure relates to a method and system for providing NFT-based digital items. More specifically, the present disclosure relates to a method and system for providing NFT-based digital items that adjust the probability of success in drawing by tuning the difficulty level of a quiz.

### BACKGROUND ART

Fandom refers to a person or group of people who passionately like or are immersed in a specific person (especially a celebrity) or field, and this fandom culture is evolving into a new industry that creates new economic value as this fandom culture spreads to various fields.

For example, various digital goods for each artist supported by each fandom, such as digital photo cards, may be provided to fans (users) through methods such as drawing (Gacha), categorized into high, medium, and low grades based on quality and rarity, similar to probability-based items provided in online game services, and fans may improve the grade of the digital items provided by using a synthesizing and reinforcing method.

Recently, the “Probability Item Regulation Bill” has been proposed to regulate the provision of Gacha services without disclosing the Gacha probability, thereby requiring that the component ratio and type of obtainable items, as well as the probability of receiving an item, be specified.

However, since the specified probabilities are provided unilaterally by the site providing the service, there is still a possibility that a provider may manipulate the probabilities.

Additionally, since items obtained through item synthesis are random items that do not reflect the choice of a user, there was an issue where, for fans who support a specific artist, the satisfaction level greatly dropped if the artist supported by the fans was not dispensed.

With the recent groundbreaking development of blockchain technology, the utilization of non-fungible tokens (NFTs) based thereon is expanding into various fields.

Herein, the NFT refers to a virtual token that proves the ownership of a digital asset using blockchain technology.

In detail, the NFT may be a type of virtual certificate of authenticity used to indicate its unique originality and ownership by including an address indicating a digital file, such as a certain image, video, and/or audio, in a token.

In other words, the NFT may mean a unique digital file format registered on a blockchain, and such NFT has the advantage that its economic value may gradually increase over time, so interest in the NFT is also increasing.

### DETAILED DESCRIPTION OF INVENTION

### TECHNICAL PROBLEMS

The present disclosure has been devised to obviate the above limitation of the related art. An aspect of the present disclosure is directed to providing a method and system for providing NFT-based digital items.

In addition, an aspect of the present disclosure is directed to providing a method and system for providing NFT-based digital items that digitalize artist IP-based content products into digital assets.

In addition, an aspect of the present disclosure is directed to providing a method and system for providing NFT-based digital items by presenting a quiz about an artist and providing digital items based on the results of the quiz.

In addition, an aspect of the present disclosure is directed to providing a method and system for providing NFT-based digital items that adjust the possibility of success in drawing/reinforcement/synthesis by setting a quiz with differential difficulty level according to the grade of the digital items.

In addition, an aspect of the present disclosure is directed to providing a method and system for providing NFT-based digital items that manage difficulty level based on the success rate of acquiring digital items according to the setting of a quiz.

In addition, an aspect of the present disclosure is directed to providing a method and system for providing NFT-based digital items that provide the digital items reflecting the tastes of fans.

### TECHNICAL SOLUTION

A method for providing non-fungible token (NFT)-based digital items, according to an embodiment of the present disclosure, is a method by which a user terminal executed through at least one processor of the user terminal provides the NFT-based digital items, and includes: inputting a plurality of digital items owned by a user, and executing synthesis to acquire at least one new digital item; determining grade data and a target artist of the new digital item based on the plurality of input digital items; determining, based on the determined grade data, a difficulty level of reference quiz data to be set as a quiz test; determining, based on the determined target artist, a target artist of the reference quiz data to be set as the quiz test; setting, as a quiz test, first reference quiz data corresponding to the determined difficulty level and the target artist; and determining, based on response data submitted for the quiz test, whether to acquire the new digital item and a grade thereof.

In this connection, the digital item is an NFT in which digital data of digital content including artist-related content is registered on a blockchain.

In addition, the digital data of the digital item includes NFT media data, NFT metadata, and NFT smart contract data. The NFT media data includes main content including an artist image, and sub-content including at least one of an artist-related text or auditory. The NFT metadata includes at least one or more of description information, creator information, or storage address information for the digital item. The NFT smart contract data includes at least one or more of owner information, transaction history information, condition information, or price information for the digital item.

In addition, the reference quiz data includes at least one of the following data: artist name, artist group name, artist information data, question creation date, question type, question data, answer type, answer data, correct answer rate, difficulty level, and digital item issuance rate.

In addition, the method for providing the NFT-based digital items according to an embodiment of the present disclosure further includes constructing a question bank database including at least one piece of reference quiz data in a server providing the synthesis.

In addition, the construction of the question bank database includes: conducting a mock test for a plurality of users based on a plurality of pieces of new quiz data; calculating a correct answer rate for each of the plurality of pieces of new quiz data based on results of the mock test for the plurality of users and determining the difficulty level based on the calculated correct answer rate; including the new quiz data for which the difficulty level has been determined as the reference quiz data in the question bank database; and providing a reward to the plurality of users who have conducted the mock test.

In addition, the determination of the grade data and target artist of the new digital item based on the plurality of input digital items includes: extracting at least one or more pieces of data among a personal name of a first artist, a group name to which the first artist belongs, a gender of the first artist, and a first grade that match a first digital item of the plurality of input digital items; extracting at least one or more pieces of data among a personal name of a second artist, a group name to which the second artist belongs, a gender of the second artist, and a second grade that match a second digital item of the plurality of input digital items; and determining an artist or artist group that matches the data extracted from the first digital item and the second digital item as the target artist.

In addition, the determination, based on the determined grade data, of the difficulty level of the reference quiz data to be set as the quiz test includes: establishing a synthesis success rate of the new digital item of the grade data of a predetermined level through the synthesis; determining the correct answer rate corresponding to the established synthesis success rate as the difficulty level; and establishing at least one piece of reference quiz data included in the determined difficulty level as a setting range.

In addition, the determination, based on the determined target artist, the target artist of the reference quiz data to be set as the quiz test includes: determining an individual artist as the target artist when individual names of the first and second artists are the same; determining a group to which the artist belongs as the target artist when the individual names of the first and second artists are different but group names to which the first and second artists belong are the same; and determining one of the first and second individual artists as the target artist when the individual names of the first and second artists and the group names to which the first and second artists belong are different but genders of the first and second artists are the same.

In addition, the setting, as the quiz test, of the first reference quiz data corresponding to the determined difficulty level and the target artist includes: randomly determining the first reference quiz data included in the setting range from among all pieces of reference quiz data for the determined target artist stored in the question bank database.

In addition, the method for providing the NFT-based digital items according to an embodiment of the present disclosure further includes deleting the first reference quiz data from the question bank database after the quiz test is set and a user answers correctly, and a digital item is issued to the user when the first reference quiz data is of the highest difficulty level included within a predetermined setting range.

A system for providing NFT-based digital items according to an embodiment of the present disclosure includes: at least one display that outputs digital item content; at least one memory; and at least one processor, wherein at least one application that is stored in the memory and executed by the processor to provide the NFT-based digital items: input a plurality of digital items owned by a user, and execute synthesis to obtain at least one new digital item; determine grade data and a target artist of the new digital item based on the plurality of input digital items; determine, based on the determined grade data, a difficulty level of reference quiz data to be set as a quiz test; determine, based on the determined target artist, a target artist of the reference quiz data to be set as the quiz test; set, as a quiz test, first reference quiz data corresponding to the determined difficulty level and the artist; and determine, based on response data submitted for the quiz test, whether to acquire the new digital item and the grade thereof.

### EFFECT OF INVENTION

A method and system for providing NFT-based digital items according to an embodiment of the present disclosure can prevent illegal copying and distribution of counterfeit products impersonating IP by digitally assetizing artist IP-based content products.

In addition, the method and system for providing the NFT-based digital items according to an embodiment of the present disclosure can exclude the possibility of probability manipulation by setting a quiz about an artist and issuing digital items according to the quiz results.

In addition, the method and system for providing the NFT-based digital items according to an embodiment of the present disclosure can reduce gambling by setting a quiz with a differential difficulty level according to a grade of the digital items and adjusting the success probability of drawing/reinforcement/synthesis.

In addition, the method and system for providing the NFT-based digital items according to an embodiment of the present disclosure can manage the difficulty level based on the success rate of acquiring the digital items according to the quiz setting, thereby applying a reasonable difficulty level to the grade of the digital items and maintaining the rarity of the corresponding digital items.

In addition, the method and system for providing the NFT-based digital items according to an embodiment of the present disclosure can improve satisfaction of fans and induce high participation of fans by issuing the digital items reflecting the tastes of fans.

### BRIEF DESCRIPTION OF THE DRAWING

FIG. 1 is a conceptual diagram illustrating a system for providing NFT-based digital items according to an embodiment of the present disclosure.

FIG. 2 is an internal block diagram illustrating a user terminal according to an embodiment of the present disclosure.

FIG. 3 is an internal block diagram illustrating a digital item provision service server according to an embodiment of the present disclosure.

FIG. 4 is a flowchart illustrating a method for constructing a question bank database according to an embodiment of the present disclosure.

FIG. 5 is an example showing reference quiz data stored in a question bank database according to an embodiment of the present disclosure.

FIG. 6 is a flowchart illustrating a method for providing digital items by a drawing method according to an embodiment of the present disclosure.

FIG. 7 is an example of a quiz test according to an embodiment of the present disclosure.

FIG. 8 is a flowchart illustrating a method for providing digital items by a synthetizing method according to an embodiment of the present disclosure.

FIG. 9 is an example of a digital item provided according to an embodiment of the present disclosure.

FIG. 10 is an example of a UI for selecting main content of a digital item according to an embodiment of the present disclosure.

FIG. 11 is an example of a UI for selecting sub-content of a digital item according to an embodiment of the present disclosure.

### BEST MODE FOR CARRYING OUT THE INVENTION

Embodiments of the present disclosure will be shown in the drawings and described in detail through a detailed description. However, the present disclosure may be variously modified and embodied in a variety of different embodiments. Advantages and features of the present disclosure and implementation methods thereof will be clarified through the following embodiments described with reference to the accompanying drawings. Therefore, the present disclosure is not limited to these embodiments introduced hereinafter and might be embodied in a different shape from these embodiments. The terms “first,” “second,” and so on in the present disclosure are used for distinguishing one component from the other components, but they do not specify limited meanings. Also, the singular forms used in the present disclosure are intended to include the plural forms, unless the context clearly indicates otherwise. Moreover, the terms “comprises” and/or “having” described in the present disclosure specify the presence of stated components and/or features, but do not preclude the presence or addition of one or more other components and/or features. Furthermore, the size or the thickness of each component in the drawings can be exaggerated or reduced for the definiteness of explanation. For example, the size and the thickness of each component in the drawings are arbitrarily represented for the convenience of explanation. In accordance therewith, the present disclosure is not limited to the matters shown in the drawings.

Reference will now be made in detail to the embodiments of the present disclosure with reference to the accompanying drawings. Wherever possible, the same reference numbers will be used throughout the disclosure including the drawings to refer to the same or like parts. As such, the repeatable description of the same or like parts will be omitted.

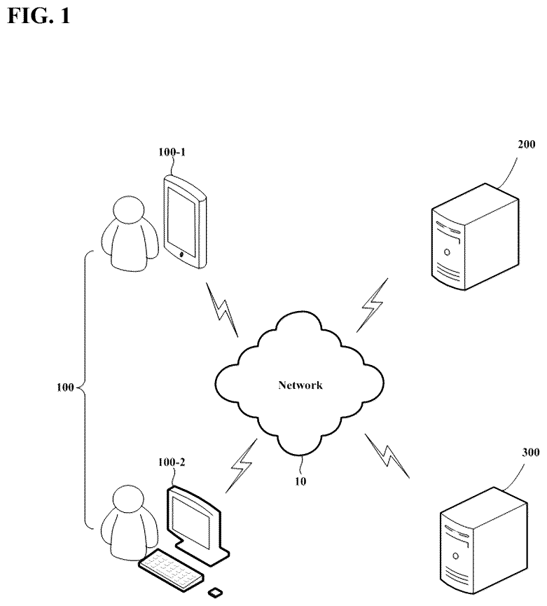

FIG. 1 is a conceptual diagram illustrating a system for providing NFT-based digital items according to an embodiment of the present disclosure.

Referring to FIG. 1 a system 10 for providing the NFT-based digital items according to an embodiment of the present disclosure (hereinafter, a “digital item provision system”) may provide a service that set a predetermined quiz with an adjusted difficulty level based on the rarity/grade of a digital item when drawing, reinforcing, or synthesizing the digital item to which an NFT is applied, and provides the digital item only to users who answer the quiz correctly (hereinafter, a “digital item provision service”).

The digital item provision system according to an embodiment of the present disclosure may provide digital items, which are artist-specific goods that have been digitally assetized, by issuing digital items in which a unique value is assigned to each artist-specific goods through blockchain.

The digital item refers to a product that includes certain content produced digitally, such as texts, sound, images, and video, and in an embodiment, may refer to digital content related to an artist (for example, digital photo cards).

In an embodiment, the digital item may be applied with the NFT, and thus may be traded in cryptocurrency and purchased/traded/exchanged on a cryptocurrency exchange for each fan to collect and own.

In this connection, the digital items may be reinforced and synthesized between digital items to improve their quality, such as by collecting digital items with high rarity or adding certain content to digital items in possession.

In addition, in an embodiment, the digital item may be initially provided to a user through at least one of a designated or random drawing method.

In an embodiment, such digital items may include NFT media data, NFT metadata, and NFT smart contract data.

The NFT media data refers to the original data, which includes the content itself, including letters, sounds, images, and videos related to tan artist.

In addition, the NFT metadata includes data related to the original data, such as description information, creator information, and storage address information.

In addition, the NFT smart contract data is related to digital items as assets, including owner information, transaction history information, condition information, and price information.

In an embodiment, the asset value of such digital items may be determined by changing the price information included in the NFT smart contract data according to the rarity of the content of the NFT media data included in the digital item.

To this end, in an embodiment, digital items may have a grade established for each digital item based on its rarity.

The grade of the digital items may be assigned using numbers, alphabets, and stars, and an administrator may determine the grade based on its rarity and match the grade to each digital item in advance. In this connection, the rarer the digital item, the higher the grade the digital item may have.

For example, a plurality of types of digital photo cards of Artist A may have grades matched according to their rarity, such as C grade/B grade/A grade/S grade/SS grade, etc.

In an embodiment, synthesis between digital items may be supported to provide a digital item of a higher grade than the grade of a digital item selected as a synthesis material.

In other words, in an embodiment, synthesis between digital items may be supported so that a digital item selected as a synthesis material may be replaced and provided with a rarer digital item.

In addition, in an embodiment, a digital item may increase the asset value of the digital item by improving the grade of the digital item according to the quantity and quality of the content of the NFT media data included in the digital item.

To this end, in an embodiment, certain content may be added to NFT media data included in a digital item through reinforcement and upgrade, or the quality of conventional content may be improved.

For example, by reinforcing and upgrading a digital photo card of Artist A, content such as effects, album title texts, the audio files of the artist, and autographed images may be added to the NFT media data, or the resolution of photos and videos included in the NFT media data may be increased, or the playback length of audio files may be extended.

In other words, the higher the grade of a digital item, the more likely it is that the quantity or quality of the content included in the digital item will be increased.

When drawing/reinforcing/synthesizing digital items according to an embodiment of the present disclosure, a predetermined quiz with adjusted difficulty level may be set based on the grade of the matched digital item.

In addition, digital items that a user may acquire through drawing/reinforcement/synthesis may be provided to the user when a quiz is set to the user when the user requests to acquire the digital item, and the user answers the set quiz correctly.

For example, when the grade of the digital item that a user may acquire is low, a quiz with low difficulty level may be set so that the user has a high probability of acquiring the digital item. When the grade of the digital item that the user may acquire is high, a quiz with high difficulty level may be set so that the user has a low probability of acquiring the digital item.

In an embodiment, the digital item provision system providing the digital item provision service as described above may include a user terminal 100, a digital item provision service server 200, an NFT service provision server 300, and a network 10.

In this connection, the user terminal 100, the digital item provision service server 200, and the NFT service provision server 300 may be connected through the network 10.

Herein, the network 10 according to an embodiment refers to a connection structure capable of exchanging information between nodes such as the user terminal 100, the digital item provision service server 200, and/or the NFT service provision server 300. Examples of the network 10 include 3GPP (3 rd Generation Partnership Project) network, LTE (Long Term Evolution) network, WIMAX (World Interoperability for Microwave Access) network, Internet, LAN (Local Area Network), Wireless LAN (Wireless Local Area Network), WAN (Wide Area Network), PAN (Personal Area Network), Bluetooth network, Satellite Broadcasting Network, Analog Broadcasting Network, and DMB (Digital Multimedia Broadcasting) network, but are not limited thereto.

Hereinafter, the user terminal 100, the digital item provision service server 200, and the NFT service provision server 300 that implement the digital item provision system will be described in detail with reference to the attached drawings.

### User Terminal 100

The user terminal 100 according to an embodiment of the present disclosure may be a computing device having a fan platform application (hereinafter, an “application”) installed that provides the digital item provision service.

Herein, the fan platform may mean an online platform that provides artist-related digital items for various fandoms that support artists and artist groups, and set artist-related quizzes to manage (for example, upgrade, reinforce, and synthesize) digital items owned by each fan.

Specifically, from a hardware point of view, the user terminal 100 may include a mobile-type computing device 100-1 and/or a desktop-type computing device 100-2 in which the application is installed.

Herein, the mobile-type computing device 100-1 may be a mobile device such as a smartphone or tablet PC in which the application is installed.

For example, the mobile-type computing device 100-1 may include a smartphone, a mobile phone, a digital broadcasting terminal 100, a personal digital assistant (PDA), a portable multimedia player (PMP), and a tablet PC.

In addition, the desktop-type computing device 100-2 may include a device installed with a program to execute the digital item provision service based on wired/wireless communication such as a fixed-type desktop PC, a laptop computer, and a personal computer such as an ultrabook in which the application is installed.

In addition, according to an embodiment, the user terminal 100 may further include a predetermined server computing device that provides a digital item provision service environment.

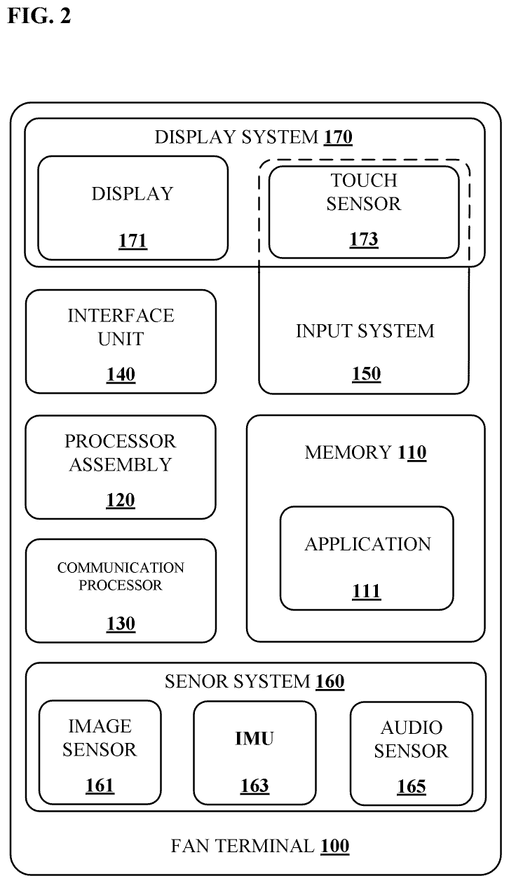

FIG. 2 is an internal block diagram of a user terminal according to an embodiment of the present disclosure.

Referring to FIG. 2, from a functional point of view, the user terminal 100 may include a memory 110, a processor assembly 120, a communication processor 130, an interface unit 140, an input system 150, a sensor system 160, and a display system 170. These components may be configured to be included within a housing of the user terminal 100.

Specifically, the memory 110 may store an application 111, and the application 111 may store one or more of various application programs, data, and commands for providing the digital item provision service environment.

In other words, the memory 110 may store commands and data used for creating the digital item provision service environment.

In addition, the memory 110 may include a program area and a data area.

Herein, the program area according to an embodiment may be linked between an operating system (OS) for booting the user terminal 100 and functional elements, and the data area may store data generated according to the use of the user terminal 100.

In addition, the memory 110 may include at least one non-transitory computer-readable storage medium and a temporary computer-readable storage medium.

For example, the memory 110 may be various storage devices, such as a ROM, an EPROM, a flash drive, and a hard drive; and may be a web storage performing a storage function of the memory 110 on the Internet.

The processor assembly 120 may include at least one processor capable of executing commands of the application 111 stored in the memory 110 to perform various tasks for creating the digital item provision service environment.

In an embodiment, the processor assembly 120 may control the overall operation of components through the application 111 of the memory 110 in order to provide the digital item provision service.

The processor assembly 120 may be a system-on-chip (SOC) suitable for the user terminal 100 that includes a central processing unit (CPU) and/or graphics processing unit (GPU), may execute the OS and/or an application program stored in the memory 110, and control each component mounted on the user terminal 100.

In addition, the processor assembly 120 may communicate with each component internally through a system bus and may include one or more predetermined bus structures including a local bus.

In addition, the processor assembly 120 may be implemented by using at least one of application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or electric units for performing other functions.

The communication processor 130 may include one or more devices for communicating with an external device. The communication processor 130 may communicate through a wireless or wired network.

In detail, the communication processor 130 may communicate with the user terminal 100 storing a content source for implementing the digital item provision service environment, and may communicate with various user input components such as a controller receiving a user input.

In an embodiment, the communication processor 130 may transmit/receive various pieces of data related to the digital item provision service to/from another user terminal 100, the digital item provision service server 200, the NFT service provision server 300 and/or an external server.

This communication processor 130 may wirelessly transmit and receive data with at least one of a base station, an external user terminal 100, or an arbitrary server on a mobile communication network built through a communication device capable of performing technical standards or communication methods (for example, LTE (Long Term Evolution), LTE-A (Long Term Evolution-Advanced), 5G NR (New Radio), and WIFI) for mobile communication.

The interface unit 140 may communicatively connect the user terminal 100 with one or more other devices. Specifically, the interface unit 140 may include wired and/or wireless communication devices that are compatible with one or more different communication protocols.

The user terminal 100 may be connected to various input/output devices through the interface unit 140.

For example, the interface unit 140 may be connected to an audio output device such as a headset port or a speaker to output audio.

Although it has been described as an example that the audio output device is connected through the interface unit 140, an embodiment in which the audio output device is installed in the user terminal 100 may also be included.

In addition, for example, the interface unit 140 may be connected to an input device such as a keyboard and/or mouse to acquire user input.

This interface unit 140 may include at least one of a wired/wireless headset port, an external charger port, a wired/wireless data port, a memory card port, a port for connecting a device equipped with an identification module, an audio input/output (I/O) port, a video I/O port, an earphone port, a power amplifier, an RF circuit, a transceiver or other communication circuits.

The input system 150 may sense a user input (for example, a gesture, a speech command, operation of a button, or other type of input) related to the digital item provision service.

Specifically, the input system 150 may include a predetermined button, a touch sensor, and/or an image sensor 161 that receives a user motion input.

In addition, the input system 150 may be connected to an external controller through the interface unit 140 to receive a user input.

The sensor system 160 may include various sensors such as an image sensor 161, a position sensor (IMU) 163, an audio sensor 165, a distance sensor, a proximity sensor, and a contact sensor.

Herein, the image sensor 161 may capture an image and/or a video of a physical space around the user terminal 100.

In an embodiment, the image sensor 161 may capture and acquire various images and/or videos related to the digital item provision service.

In addition, the image sensor 161 may be disposed on the front or/and rear side of the user terminal 100 to acquire an image by capturing the disposed direction side, and may capture a physical space through a camera disposed toward the outside of the user terminal 100.

The image sensor 161 may include an image sensor device and a video processing module. Specifically, the image sensor 161 may process a still image or a moving image obtained by an image sensor device (for example, CMOS or CCD).

In addition, the image sensor 161 may process a still image or a moving image obtained through the image sensor device using an image processing module to extract necessary information, and transmit the extracted information to a processor.

The image sensor 161 may be a camera assembly including at least one or more cameras. The camera assembly may include a general camera that captures a visible light band, and may further include a special camera such as an infrared camera or a stereo camera.

In addition, the aforementioned image sensor 161 may be operated while being included in the user terminal 100 according to an embodiment, or may be included in an external device (for example, an external server) to operate through interworking based on the aforementioned communication processor 130 and/or interface unit 140.

The IMU 163 may sense at least one of motion and acceleration of the user terminal 100. For example, the IMU 163 may include a combination of various position sensors such as an accelerometer, a gyroscope, and a magnetometer.

In addition, the IMU may interwork with the position communication processor 130 such as GPS of the communication processor 130 to recognize spatial information on the physical space around the user terminal 100.

The audio sensor 165 may recognize a sound around the user terminal 100.

In detail, the audio sensor 165 may include a microphone capable of sensing a speech input of a user using the user terminal 100.

In an embodiment, the audio sensor 165 may receive speech data necessary for the digital item provision service from a user.

The display system 170 may output various pieces of information related to the digital item provision service as a graphic image.

In an embodiment, the display system 170 may display various pieces of data and/or user interfaces based on the activities of a user using the application 111.

Such display may include at least one of a liquid crystal display (LCD), a thin film transistor-liquid crystal display (TFT LCD), an organic light-emitting diode (OLED), and a flexible display, a 3D display, or an electronic ink display (e-ink display).

The above components may be disposed within the housing of the user terminal 100, and a user interface may include a touch sensor 173 on a display 171 configured to receive a user touch input.

In detail, the display system 170 may include the display 171 that outputs an image and the touch sensor 273 that senses a user touch input.

For example, the display 171 may form an overlaid structure with the touch sensor 173 or integrally formed to be implemented as a touch screen. Such a touch screen may function as a user input unit that provides an input interface between the user terminal 100 and the user, and may provide an output interface between the user terminal 100 and the user.

In addition, according to an embodiment, the user terminal 100 may further perform at least a portion of functional operations performed by the digital item provision service server 200 and/or the NFT service provision server 300, which will be described later.

-Digital Item Provision Service Server 200 The digital item provision service server 200 (hereinafter, a “service server 200”) according to an embodiment of the present disclosure may perform a series of processes for providing the digital item provision service.

In detail, in an embodiment, the service server 200 may provide the digital item provision service by exchanging data necessary to enable for a digital item provision process to drive in an external device such as the user terminal 100 with the external device.

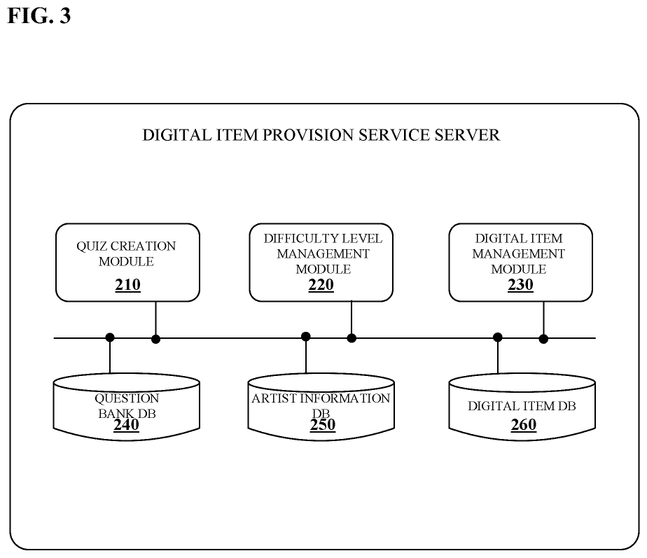

FIG. 3 is an internal block diagram illustrating a digital item provision service server according to an embodiment of the present disclosure.

Referring to FIG. 3, in an embodiment, the service server 200 may include a quiz creation module 210, a difficulty level management module 220, a digital item management module 230, a question bank database 240, an artist information database 250, and a digital item database 260 to provide the digital item provision service.

In this connection, depending on an embodiment, each of the components may be implemented as a separate device from the service server 200 or may be implemented by being included in the service server 200. Hereinafter, each component is described as being implemented by being included in the service server 200, but is not limited thereto.

Specifically, in an embodiment, the quiz creation module 210 may construct the question bank database 240 according to an embodiment of the present disclosure.

To this end, the quiz creation module 210 may create at least one piece of quiz data based on predetermined artist information data (in an embodiment, the photo, video, voice, sound source, and detailed information of an artist) included in the artist information database 250.

In an embodiment, the artist information data may refer to various pieces of information about an artist who is the target of a quiz, and may include, for example, content including the photo, video, voice, and sound source of the artist to be included in the quiz, and a profile including the hometown, academic background, and debut date of the artist.

Hereinafter, quiz data before a difficulty level is determined may be referred to as new quiz data, and quiz data whose difficulty level is determined by having a plurality of users solve the new quiz data a preset number of times (for example, 100 times or more) may be referred to as reference quiz data.

In an embodiment, the new quiz data may include artist name and/or artist group name, artist information data, question creation date, question type (for example, video/audio/image/text, etc.) and question data, answer type (for example, multiple choice/subjective, etc.) and answer data, correct answer rate, and difficulty level.

In this connection, the correct answer rate and difficulty level may be determined after at least one user solves the created new quiz data, and may be a default value (for example, 0) in the new quiz data before the user solves the same.

In addition, in an embodiment, the quiz creation module 210 may extract at least one or more pieces of artist information data presently stored in the artist information database 250.

In this connection, the extracted artist information data may be the source of quiz data created by the quiz creation module 210 in an embodiment.

In addition, in an embodiment, the quiz creation module 210 may create at least one piece of new quiz data based on user input of inputting and/or selecting an artist name and/or artist group name, a question creation date, a question type (for example, video/audio/image/text, etc.) and an answer type (for example, multiple choice/subjective, etc.) for the extracted artist information data.

The subject who creates the new quiz data based on the user input may be an administrator and/or a user of the user terminal 100 on which the fan platform application is installed (hereinafter, “user”).

In this connection, the new quiz data created based on the user input through direct user participation may be stored in the question bank database 240 after going through a review process by an administrator.

For example, the quiz creation module 210 may create new quiz data that guesses which artist it is by exposing only a portion (for example, hair, hands, or clothing) of the image and video of artist A based on the information data of artist A included in the artist information database 250.

In addition, for example, the quiz creation module 210 may create new quiz data that guesses which artist it is by playing only a portion of the voice and sound source of artist A (for example, 1 second of the sound source introduction) based on the information data of artist A included in the artist information database 250.

In addition, for example, the quiz creation module 210 may create new quiz data that discloses artist A and guesses date of birth, album release date, debut date, and tastes of artist A, based on the information data of artist A included in the artist information database 250.

In other words, in an embodiment, the quiz creation module 210 may create at least one piece of new quiz data based on input from an administrator and a user and store the same in the question bank database 240.

At least one piece of new quiz data created by the quiz creation module 210 and stored in the question bank database 240 may be set in a mock test, which is a quiz for determining a difficulty level.

In addition, in an embodiment, the difficulty level management module 220 may determine the difficulty level of at least one piece of new quiz data stored in the question bank database 240.

For example, the difficulty level may be expressed using numbers from 0 to 100, with higher numbers indicating higher difficulty level, or may be expressed by dividing the difficulty level into predetermined classes such as very easy/easy/normal/difficult/very difficult.

To this end, in an embodiment, at least one piece of new quiz data stored in the question bank database 240 may be set in the mock test.

Accordingly, at least one user may perform a mock test based on the fan platform application stored in the user terminal 100 to solve at least one piece of new quiz data.

In an embodiment, the difficulty level management module 220 may calculate the correct answer rate of the user for each new piece of quiz data set in the mock test, and determine the difficulty level of the new piece of quiz data based on the correct answer rate.

In other words, in an embodiment, the difficulty level management module 220 may determine the difficulty level of at least one piece of new quiz data stored in the question bank database 240 based on the correct answer rate of the user who solved the predetermined new quiz data based on the mock test.

Accordingly, in an embodiment, the difficulty level management module 220 may construct the question bank database 240 by converting new quiz data with determined difficulty level into reference quiz data and storing the same.

At least one piece of reference quiz data stored in the question bank database 240 may be set in a practical test, which is a quiz that is set when a user attempts to acquire a digital item through drawing or synthesis, or attempts to upgrade the digital item through reinforcement, in the fan platform application according to an embodiment.

In an embodiment, new quiz data and reference quiz data set in mock tests and practical tests may include the same quiz content, differing only in whether it is before or after the difficulty level is determined, and only predetermined data included in the quiz content may be changed as the difficulty level is tuned.

In addition, in an embodiment, the difficulty level management module 220 may manage the difficulty level of at least one piece of reference quiz data.

In an embodiment, the reference quiz data may further include a digital item issuing rate in addition to the artist name and/or artist group name, artist information data, question creation date, question type, question data, answer type, answer data, correct answer rate, and difficulty level.

In an embodiment, the digital item issuing rate may be a value representing the number of digital items issued according to the correct answer of a user relative to the number of questions set.

In detail, in an embodiment, the difficulty level management module 220 may tune the difficulty level by changing predetermined data included in at least one piece of reference quiz data based on the digital item issuing rate of a user.

To this end, in an embodiment, the difficulty level management module 220 may change predetermined data included in the reference quiz data when the digital item issuing rate exceeds a preset criterion, determining that the question is frequently set and a user has a high probability of getting the answer right.

In detail, in an embodiment, the difficulty level management module 220 may tune the difficulty level of the first reference quiz data by changing the exposure range and/or answer type of artist information data included in the first reference quiz data for which the digital item issuing rate exceeds a preset criterion.

In addition, in an embodiment, the digital item management module 230 may add the number of content included in the digital item or increase the quality according to the result of reinforcing the digital item.

In addition, in an embodiment, the digital item management module 230 may replace a digital item owned by a user with another digital item depending on the result of synthesizing the digital item.

In addition, in an embodiment, the digital item management module 230 may trade (for example, purchase/sell/exchange, etc.) a predetermined digital item having value as a cryptocurrency by linking with an external server 300.

In addition, in an embodiment, the question bank database 240 may store and manage at least one piece of quiz data.

In detail, in an embodiment, the question bank database 240 may store and manage at least one piece of quiz data (in an embodiment, new quiz data and reference quiz data) by classifying the same according to a predetermined criterion (for example, by individual artist, by group, or by difficulty level).

In this connection, in an embodiment, at least one piece of reference quiz data included in the question bank database 240 may be sorted in order of difficulty level. Accordingly, by establishing the upper percentage of the sorted difficulty level, only reference quiz data that includes the corresponding range of difficulty levels may be extracted, which will be described in detail later.

In addition, in an embodiment, the artist information database 250 may store and manage at least one or more pieces of artist information data.

In detail, in an embodiment, the artist information database 250 may store and manage at least one or more pieces of artist information data by classifying the same according to a predetermined criterion (for example, by individual artist, or by group).

In addition, in an embodiment, the digital item database 260 may store and manage at least one digital item.

In addition, in an embodiment, the digital item database 260 may store and manage digital item content (for example, photos and videos for producing digital photo cards, handwritten text images, or artist voice audio files) that serve as sources for producing digital items.

In detail, in an embodiment, the digital item database 260 may store and manage at least one digital item and digital item content by classifying the same according to a predetermined criterion (for example, by individual artist, by group, or by level).

In addition, in an embodiment, the question bank database 240, the artist information database 250, and the digital item database 260 may store and manage various application programs, applications, commands, and/or data for implementing the digital item provision service.

The service server 200 including the components as described above may implement the digital item provision service by exchanging data required for the digital item provision process to be driven by an external device such as the user terminal 100 with the external device.

In more detail, in an embodiment, the service server 200 may provide an environment in which the application 111 may operate in an external device (in an embodiment, the mobile-type computing device 100-1 and/or the desktop-type computing device 100-2).

To this end, the service server 200 may include application programs, data and/or commands for the application 111 to operate, and may transmit and receive various pieces of data based thereon with the external device.

In addition, in an embodiment, the service server 200 may store and manage various application programs, commands, and/or data for implementing the digital item provision service.

As an example, the service server 200 may store and manage at least one piece of quiz data, artist information data, and/or user interface.

In addition, the service server 200 may include at least one quiz creation module 210, the difficulty level management module 220, the digital item management module 230, the question bank database 240, the artist information database 250, and the digital item database 260.

However, the functional operations that the service server 200 may perform in an embodiment of the present disclosure are not limited to those described above, and other functional operations may be performed.

In an embodiment, the service server 200 as described above may be implemented as at least one computing device including at least one processor for data processing, at least one communication processor for data exchange with an external device, and at least one memory for storing various application programs, data, and/or commands for providing the digital item provision service.

Herein, the memory may store one or more of an operating system (OS), various application programs, data, and commands for providing the digital item provision service.

In addition, the memory may include the program area and the data area.

Herein, the program area according to an embodiment may be linked between the OS for booting a server and functional elements, and the data area may store data generated according to the use of the server.

In an embodiment, the memory may be various storage devices, such as a ROM, a RAM, an EPROM, a flash drive, and a hard drive, and may be a web storage performing a storage function of the memory on the Internet.

The processor may control the overall operation of each unit to implement the digital item provision service.

In addition, the operations of each module described above may be subdivided into the operations of the processor for convenience of explanation, and the entire operations performed by the quiz creation module 210, the difficulty level management module 220, and the digital item management module 230 may be performed by the processor.

In addition, the processor may be the SOC suitable for the server that includes the CPU and/or GPU, may execute the OS and/or an application program stored in the memory, and control each component mounted on the server.

In addition, the processor may communicate with each component internally through a system bus and may include one or more predetermined bus structures including a local bus.

In addition, the processor may be implemented by using at least one of the ASICs, DSPs, DSPDs, PLDs, FPGAs, controllers, micro-controllers, microprocessors, or electric units for performing other functions.

In the above description, it has been described that the service server 200 according to an embodiment of the present disclosure performs the functional operation as described above. However, according to an embodiment, various embodiments may be possible, such as performing at least a portion of the functional operation performed by the service server 200 (for example, the user terminal 100), and further performing at least a portion of the functional operation performed in the external device in the service server 200.

### External Server 300

The external server 300 according to an embodiment of the present disclosure may provide predetermined data that may be utilized on the digital item provision service to the user terminal 100 and/or the service server 200.

In detail, in an embodiment, the external server 300 may be a server that implements an external service that may support transactions of digital items (in an embodiment, purchase and sale of artist-related digital items for various fandoms supporting artists and artist groups) based on the fan platform application.

For example, such external servers 300 may include a cryptocurrency trading platform server.

In an embodiment, the external server 300 as above may include at least one data transmission and reception unit, a processor unit, or a database.

First, the data transmission and reception unit according to an embodiment may transmit and receive various pieces of data for supporting the digital item provision service through the network 10 in conjunction with an external device (for example, the user terminal 100 and/or the service server 200).

As an example, the data transmission and reception unit 310 may transmit and receive external service-based fan activity data with the user terminal 100 and/or the service server 200 through a network.

In addition, the database according to an embodiment may store and manage various pieces of data for supporting the digital item provision service.

In an embodiment, the database may store and manage at least one of the OS, various application programs, data, and commands for implementing a predetermined external service, and may store and manage predetermined data based on the external service.

These databases may be various storage devices, such as a ROM, a RAM, an EPROM, a flash drive, and a hard drive, and may also be web storage performing a storage function of the database on the Internet.

In addition, the processor unit according to an embodiment may control the overall operation of each component described above for implementing the digital item provision service.

The processor unit may be implemented using at least one of the ASICs, the DSPs, the DSPDs, the PLDs, the FPGAs, controllers, micro-controllers, microprocessors, or electric units for performing other functions.

### Method for Constructing Question Bank Database by Performing Mock Test

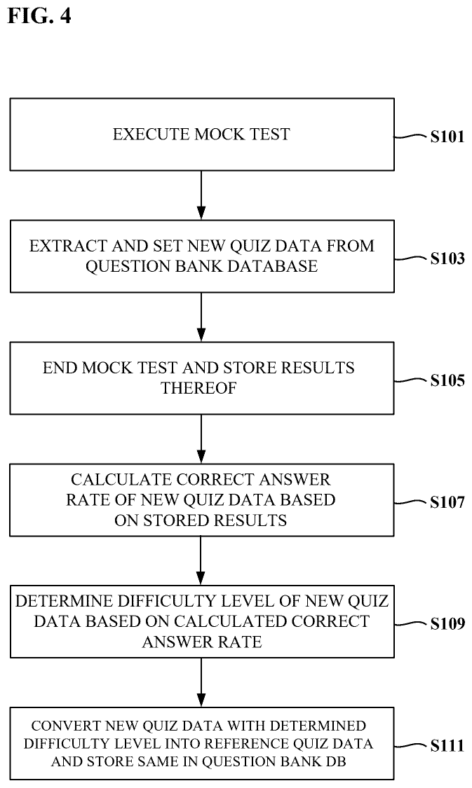

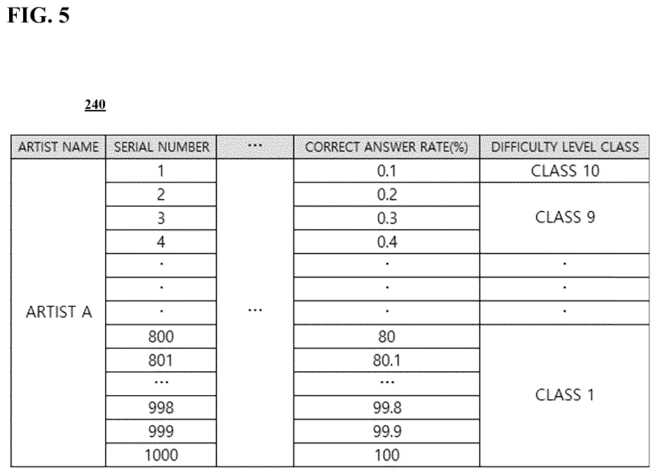

Hereinafter, a method for constructing the question bank database 240 by performing a mock test based on the fan platform application by the application 111 executed by at least one processor of the user terminal 100 according to an embodiment of the present disclosure will be described in detail with reference to the attached FIGS. 4 and 5.

In an embodiment of the present disclosure, at least one processor of the user terminal 100 may execute at least one application 111 stored in at least one memory 110 or operate the same in a background state.

Hereinafter, the method for constructing the question bank database 240 by operating at least one processor to execute the command of the application 111 is briefly described as being performed by the application 111.

FIG. 4 is a flowchart illustrating a method for constructing a question bank database according to an embodiment of the present disclosure.

Referring to FIG. 4, in an embodiment, the application 111 may execute a mock test (S101).

In detail, in an embodiment, the application 111 may sense user input for selecting individual artists and groups and execute a mock test related to the selected individual artists and groups accordingly.

Additionally, in another embodiment, the application 111 may extract the subscribed fandom information of a user, automatically select individual artists and groups corresponding to the fandom, and execute a mock test related to the selected individual artists and groups.

In this connection, in an embodiment, the mock test may be executed based on at least one piece of new quiz data previously created by an administrator and/or a user.

In addition, in an embodiment, the mock test may be a procedure that a plurality of users using the fan platform application 111 needs to necessarily/periodically execute in order to verify the appropriateness of the difficulty level of at least one or more pieces of quiz data stored in the question bank database 240 (more specifically, in an embodiment, determining the difficulty level of new quiz data and tuning the difficulty level of reference quiz data).

Accordingly, in an embodiment, the application 111 may establish conditions such as providing a predetermined reward (for example, fan points, concert voucher application, coupons, and discount coupons) to a user who performs the mock test, or granting the right to perform a practical test only to a user who has performed the mock test a predetermined number of times.

In addition, in an embodiment, the application 111 may recruit at least one user to perform a mock test on a specific artist.

This is to set new quiz data of artists for who have not met a preset number of times, since the difficulty level of the new quiz data stored in the question bank database 240 needs to be determined and converted and/or stored as reference quiz data only when the new quiz data has been solved by a plurality of users the preset number of times.

In an embodiment, the application 111 may provide additional rewards to users who perform mock tests regarding the specific artists recruited above.

Next, in an embodiment, the application 111 may extract and set new quiz data from the question bank database 240 (S103).

In detail, in an embodiment, the application 111 may randomly extract and set predetermined new quiz data related to the artist selected through stage S101 from the question bank database 240.

In this connection, the new quiz data includes each artist name and/or artist group name, and is stored in the question bank database 240 by individual artist and/or group, so that in an embodiment, the application 111 may randomly extract and set predetermined quiz data from among a plurality of pieces of new quiz data related to the artist selected in stage S101.

Accordingly, at least one user may solve the quiz by inputting predetermined response data to the predetermined quiz data set above. For example, a user may solve a quiz by inputting response data, such as selecting option 1 for a five-option multiple-choice quiz or inputting predetermined letters and numbers for a subjective quiz, based on the fan platform application 111 installed on each user terminal 100.

Next, in an embodiment, the application 111 may end the mock test and store the results of the mock test (S105).

In detail, in an embodiment, the application 111 may end a mock test and store the results, including the number of times set and whether the answer is correct or incorrect, for each of at least one piece of new quiz data set in the mock test.

In this connection, the number of times set may be a predetermined value calculated for converting new quiz data into reference quiz data, and the correct or incorrect answer for each of at least one piece of new quiz data set in the mock test may be provided to the user terminal 100 and disclosed to a user.

The aforementioned stages S101 to S105 may be repeatedly performed by a plurality of users using the fan platform according to an embodiment of the present disclosure, and accordingly, the number of times each new quiz data is set and whether the answer is correct or incorrect may be accumulated according to the number of times it is performed.

Next, in an embodiment, the application 111 may calculate the correct answer rate of new quiz data based on the stored results (S107).

In detail, in an embodiment, the application 111 may calculate the correct answer rate of new quiz data that satisfies a preset number of times set based on the stored results.

In an embodiment, the number of times set may be a predetermined number of times that has to be set as the minimum number in order to calculate objective statistics, and may be preset by an administrator. For example, the preset number of times set may be established to 100.

In other words, the new quiz data for which the correct answer rate is calculated in stage S107 may be new quiz data that has been set a predetermined number of times or more.

In addition, the correct answer rate may be a value that represents the number of users who answered correctly as a probability (%) compared to the number of users who solved each piece of new quiz data. For example, when the number of users who solve the quiz is 200 and the number of users who answered correctly is 10, the correct answer rate might be 10/200=5%.

Next, in an embodiment, the application 111 may determine the difficulty level of new quiz data based on the calculated correct answer rate (S109).

In detail, in an embodiment, the application 111 may determine the difficulty level of each piece of new quiz data set in a mock test based on the calculated correct answer rate of the new quiz data.

To this end, in an embodiment of the present disclosure, at least one difficulty level class with a predetermined correct answer rate range may be classified.

Accordingly, in an embodiment, the application 111 may determine the difficulty level of new quiz data by deriving a difficulty level class of a correct answer rate range that includes the calculated correct answer rate.

For example, in an embodiment, there may be first to tenth difficulty level classes, and the difficulty level may be fixed to become increasingly more difficult from the first difficulty level class to the tenth difficulty level class.

In addition, for example, the preset correct answer rate range for the first difficulty level class may be 80% to 100%. The preset correct answer rate range for the tenth difficulty level class may be 0% to 0.1%.

The examples above are merely presented for the convenience of explanation, and various embodiments may exist, such as the difficulty level itself being fixed in different ways, the difficulty level being classified into classes less than or more than the tenth difficulty class, or the correct answer rate range preset for each class being different.

In other words, in an embodiment, the application 111 may determine the derived difficulty level class as the difficulty level of new quiz data by deriving the difficulty level class corresponding to the correct answer rate range that includes the calculated correct answer rate.

Next, in an embodiment, the application 111 may convert new quiz data with a determined difficulty level into reference quiz data and store the same in the question bank database 240 (S111).

In detail, in an embodiment, the application 111 may convert new quiz data with a determined difficulty level into reference quiz data, and store and manage at least one piece of reference quiz data by classifying quiz data according to a predetermined criterion (for example, by artist).

FIG. 5 is an example showing reference quiz data stored in a question bank database according to an embodiment of the present disclosure. In detail, FIG. 5 illustrates at least one piece of reference quiz data for artist A. The portions omitted from the table may include data such as artist group name, artist information data, question creation date, question type, and answer type.

Referring to FIG. 5, in an embodiment, the application 111 may sort at least one piece of reference quiz data for artist A in order of difficulty level determined based on the correct answer rate from high to low.

For example, in an embodiment, the application 111 may sort at least one piece of reference quiz data for artist A in order from the tenth difficulty level class, where the correct answer rate range is preset to 0 to 0.1%, to the first difficulty level class, where the correct answer rate range is preset to 80 to 100%.

In this connection, in an embodiment, the application 111 may sort data from a lower correct answer rate (in other words, a higher difficulty level) to a higher correct answer rate within the same difficulty level class.

For example, the reference quiz data corresponding to serial number 2 illustrated in FIG. 5 belongs to the same difficulty level class as reference quiz data corresponding to serial number 3, but may be sorted higher than the reference quiz data corresponding to serial number 3 due to a lower correct answer rate.

In this way, in an embodiment, the application 111 may store at least one piece of reference quiz data sorted in order of difficulty level by at least one artist who has subscribed to the fan platform service.

In other words, the application 111 according to an embodiment of the present disclosure may perform a mock test based on the fan platform application and construct the question bank database 240 including at least one piece of reference quiz data classified and stored according to a predetermined criterion.

### Method for Providing Digital Item Provision Service based on Quiz Test

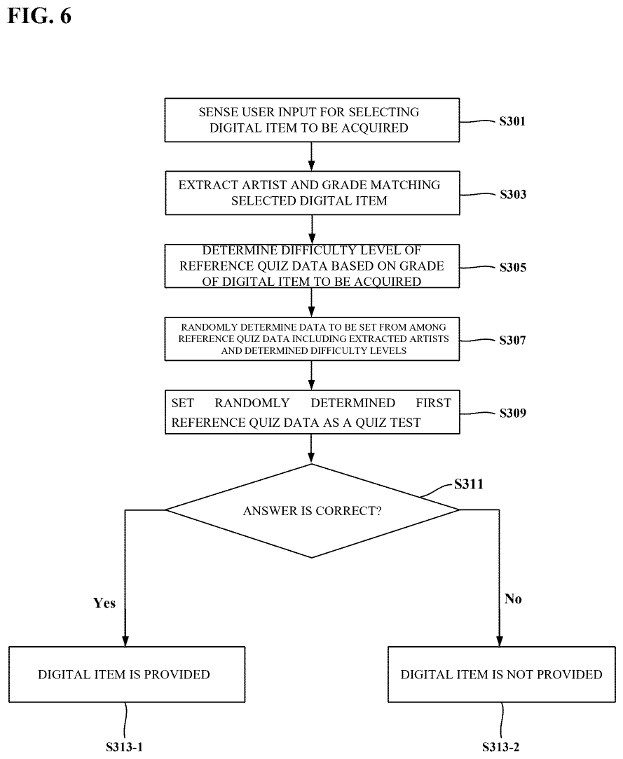

Hereinafter, a method for providing the digital item provision service in which the application 111 executed by at least one processor of the user terminal 100 according to an embodiment of the present disclosure set a predetermined quiz (a quiz test in an embodiment) whose difficulty level is adjusted based on the grade of a digital item and provides the digital item to a user who answers the quiz correctly is described in detail with reference to FIGS. 6 to 9.

In an embodiment of the present disclosure, at least one processor of the user terminal 100 may execute at least one application 111 stored in at least one memory 110 or operate the same in a background state.

Hereinafter, the method for providing the digital item provision service by operating the at least one processor to execute the command of the application 111 is briefly described as being performed by the application 111.

Prior to the description, in an embodiment, the application 111 may acquire a new digital item through at least one of a drawing method, a synthesis method, or a reinforcement method at the request of a user.

In detail, the application 111 may provide a draw function that allows a user to acquire a new digital item by paying a certain amount of money, requesting a digital item drawing method (in an embodiment, designated and/or random), and passing a quiz test.

Herein, the designated drawing method is a method in which a user designates an artist who is the target of a digital item, designates a grade of a digital item to be acquired, applies for a draw, and passes a quiz test, and then acquires a digital item randomly selected from among a plurality of digital items with the designated artist or/and grade as attributes. In addition, the random drawing method is a method in which a user applies for a draw without designating an artist or grade, and when the user passes a quiz test, the user acquires a random digital item with an artist and grade whose attributes have been randomly determined. Hereinafter, for convenience of explanation, only the designated drawing method is used as the basis.

In an embodiment of the present disclosure, in addition to the designated drawing method, a digital item may be acquired by selecting a specific digital item and using the designated purchase method. However, since the designated purchase method allows acquisition of a digital item without taking a quiz test, the price of the voucher may be sold at a higher price than the voucher for the designated drawing method.

In addition, the application 111 according to an embodiment of the present disclosure may provide a function of acquiring a digital item that is upgraded from the digital item paid for by requesting synthesis by paying for at least two or more of the digital items owned by a user in a synthesis method and then passing a quiz test.

In addition, the application 111 according to an embodiment of the present disclosure may provide a function in which, when a user pays a predetermined price (for example, goods, or reinforcement items) and passes a quiz test with a digital item that the user presently owns in a reinforcement method, the user acquires a digital item that is upgraded compared to the digital item presently owned and paid for.

The synthesis and reinforcement method provides a digital item by replacing the grade matching the paid digital item with a digital item of a higher grade than the conventionally matched grade. Regardless of whether synthesis and reinforcement succeed or fail, the paid digital item may be discarded.

In the case of these synthesis and reinforcement methods, since the paid digital items are discarded, predetermined benefits may be added, such as providing a limited edition of digital items that may not be obtained through a drawing method, or the maximum grade of digital items obtainable through the synthesis and reinforcement methods being higher than the maximum grade of digital items obtainable through the drawing method.

In addition, at least one quiz question may be included in a quiz test set when acquiring and/or upgrading a digital item based on the drawing/synthesis/reinforcement method according to an embodiment, and a digital item of a differential number and/or grade may be provided based on the quiz result.

FIG. 6 is a flowchart illustrating a method for providing digital items by a drawing method according to an embodiment of the present disclosure.

First, referring to FIG. 6 to explain a method for providing digital items in a drawing method, in an embodiment, the application 111 may sense a user input for selecting a digital item to be acquired (S301).

In detail, in an embodiment, the application 111 may sense a user input for selecting a digital item to be acquired from a total of digital items that differ by artist and/or grade.

To this end, at least one digital item may be classified by a predetermined category and stored in the digital item database 260.

For example, the predetermined category may include at least one of a first category classified by individual artists, a second category classified by group of artists, or a third category classified by grade.

In addition, in an embodiment, a user may perform a user input to select at least one attribute among the attributes of a digital item and acquire a single digital item including the selected attribute.

In this connection, the selected attribute may be an attribute of a category of the digital item database (260).

For example, a user may perform a user input to acquire a single digital item that matches “grade S” and “artist A.” In addition, in an embodiment, a user may perform a user input to acquire a digital item of package type, in which only the attributes of the first and second categories among the attributes of the digital item are selected, and the attributes of the third category are combined in any arbitrary way.

In this connection, the package may be a product including a plurality of digital items, where the artist individuals and/or groups corresponding to the first and second categories are designated, but the grade corresponding to the third category is established to a predetermined range.

For example, a user may perform a user input to acquire a digital item package matching “artist A” and/or “group A.” In this connection, the package may include a general package including a plurality of digital items with “grade C to grade S” matching among the digital items matched with “artist A” and/or “group A,” and a royal package including a plurality of digital items with “grade A to grade S” matching.

In addition, in an embodiment, a user may purchase a voucher that determines whether to acquire the selected digital item. In this connection, the amount of the voucher may vary depending on the grade of the digital item selected above.

To this end, in an embodiment, the application 111 may perform a payment process for purchasing a voucher. Accordingly, a user may purchase the voucher to acquire digital items through a drawing method by paying a predetermined amount of money.

In addition, when a digital item of a predetermined grade (for example, grade S or higher) is selected, the application 111 in an embodiment may establish predetermined conditions for purchasing a voucher to acquire the selected digital item.

For example, when a user selects a single digital item with a matching “grade S,” in an embodiment, the application 111 may establish a condition so that the purchase of a voucher to acquire the selected digital item of grade S is possible only when the user “takes the mock test more than 100 times and possesses more than 10 digital items of grade A or higher.” Next, in an embodiment, the application 111 may extract artist and grade attributes matching the selected digital item attributes (S303).

For example, when a user requests to draw with the attribute of a digital item of artist A of grade S in stage S301, in an embodiment, the application 111 may be set so that one digital item among the digital items having the attributes of “artist A” and “grade S” may be drawn.

In addition, in an embodiment, the application 111 may detect reference quiz data for artist A among at least one piece of reference quiz data stored in the question bank database 240.

In this connection, referring again to FIG. 5, the reference quiz data for the detected artist A may be detected in descending order from data with high difficulty level to data with low difficulty (for example, from the tenth difficulty level class to the first difficulty class).

Next, in an embodiment, the application 111 may determine the difficulty level of the reference quiz data based on the grade of the digital item to be acquired (S305).

In detail, in an embodiment, the application 111 may determine the difficulty level of reference quiz data to be set in the quiz test based on the grade of the digital item to be acquired by a draw.

In this connection, in an embodiment, the application 111 may establish a range of reference quiz data (hereinafter, “setting range”) that may be set for each grade among at least one piece of reference quiz data in order to determine the difficulty level of the reference quiz data based on the grade of the digital item to be acquired.

To this end, at least one piece of reference quiz data may be classified by a predetermined category and stored in the question bank database 240.

For example, the predetermined category may include a first category classified by individual artists, a second category classified by group of artists, a third category classified by difficulty level.

In an embodiment, the application 111 may establish the setting range based on a predetermined criterion matched to each grade.

To this end, in an embodiment, the application 111 may match a predetermined difficulty level class to each grade.

In an embodiment, the application 111 may determine the difficulty level of quiz data based on the grade data of a digital item to be acquired by a draw.

In detail, the application 111 may preset the drawing probability for each digital item grade data and determine the difficulty level of the quiz test submitted during the drawing and/or the number of quiz tests to match the preset drawing probability. In an embodiment, the application 111 may detect a quiz test having a difficulty level class having a correct answer probability corresponding to the draw probability of the grade data of a digital item to be drawn, and provide the detected quiz test to a user.

For example, when a draw of SS-grade digital item grade data is requested, a quiz test of the tenth difficulty level class with a correct answer probability matching the SS-grade draw probability may be detected and set.

Accordingly, in an embodiment, the application 111 may detect reference quiz data of the tenth difficulty level class among reference quiz data related to artist A storing the setting range in the question bank database 240 and provide the same as a quiz test for drawing.

In other words, the application 111 may match a predetermined upper percentage (%) value of the probability that may be acquired per grade data of a digital item that may be acquire, extract quiz data of a difficulty level class having a correct answer probability that matches the percentage value, and submit a quiz test randomly selected from among the extracted quiz data to a user.

For example, in an embodiment, the application 111 may match values in the top 0% to 0.1% for the grade SS and values in the top 80% to 100% for the grade C.

Accordingly, referring again to FIG. 5, when a user selects a digital item related to artist A with the grade SS, the application 111 in an embodiment may determine, as the setting range, the top 0% to 0.1% of reference quiz data related to the artist A sorted in order of difficulty level in the question bank database 240.

In other words, when there are a total of 1,000 pieces of reference quiz data related to artist A, the top 0.1% of reference quiz data corresponds to serial number 1, so that data may be established as the setting range.

Under the same conditions, when a user selects a digital item related to artist A of grade C, in an embodiment, the application 111 may establish the data from serial numbers 800 to 1000, which are the top 80% to 100% of reference quiz data, as the setting range.

In addition, when a user selects a general and/or royal package that includes a plurality of digital items, the setting range may be wider than when the user selects a single digital item.

As described above, in an embodiment, the application 111 may determine the difficulty level of reference quiz data to be set in the quiz test based on a predetermined criterion (for example, a predetermined difficulty level class and/or a top percent (%) value) that matches the extracted grade.

In another embodiment, the application 111 may extract a plurality of quiz tests from the question bank database 240 such that a total correct answer probability of the plurality of quiz tests matches the probability of acquiring each digital item per grade data that may be acquired. For example, a first quiz test and a second quiz test may be extracted and submitted to a user so that the total correct answer probability obtained by multiplying the correct answer probability of the first quiz test and the correct answer probability of the second quiz test matches the probability that may be acquired.

Next, in an embodiment, the application 111 may randomly determine a quiz test to be set from among reference quiz data including extracted artists and determined difficulty levels (S307).

In detail, in an embodiment, the application 111 may randomly determine at least one piece of reference quiz data from among a plurality of pieces of reference quiz data including the extracted artists and determined difficulty levels.

In this connection, at least one piece of reference quiz data randomly determined by the application 111 in an embodiment may be singular and/or plural, but may be referred to as first reference quiz data for convenience of explanation.

Next, in an embodiment, the application 111 may set randomly determined first reference quiz data as a quiz test (S309).

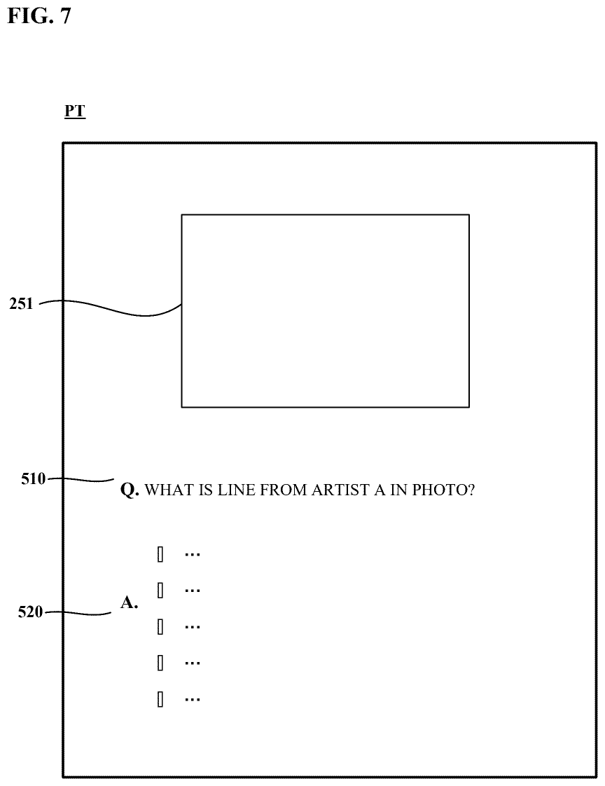

To this end, in an embodiment, when a quiz test is executed according to a user input, the application 111 may expose a plurality of pieces of data included in the randomly determined first reference quiz data on a display of the user terminal 100 in a quiz format as illustrated in FIG. 7.

FIG. 7 is an example of a quiz test according to an embodiment of the present disclosure.

Referring to FIG. 7, the quiz test may include at least one piece of artist information data 251, question data 510, and answer data 520.

The artist information data 251 provided to a user through inclusion in the quiz test may be data including at least one of the photo, video, voice, or sound source of an artist, depending on the question type included in the first reference quiz data.

In addition, the artist information data 251 may be randomly determined and may be omitted when the set first reference quiz data is not a question about the photo, video, voice, and sound source of an artist, but a question that simply asks about artist-related information in text format.

In addition, the question data 510 may be included one for each piece of reference quiz data regardless of the question type of the first reference quiz data.

In addition, the answer data 520 may include a plurality of options in the case of multiple choice, depending on the answer type included in the first reference quiz data, and may include a text box for inputting a predetermined text in the case of subjective question.

In an embodiment, a user may select at least one option from a plurality of options or input a predetermined text.

The question data 510 and the answer data 520 may change each time the quiz test proceeds to the next reference quiz data when there are the plurality of pieces of reference quiz data set as quiz tests.

In addition, a user may be required to register and submit answers to the set first reference quiz data within a predetermined period of time (for example, 3 to 5 seconds).

In this connection, in order to exclude the possibility of searching or receiving help from others when setting the first reference quiz data corresponding to the quiz test, the application 111 in an embodiment may establish conditions such as blocking the execution status of the application 111 from switching to background execution or requesting an answer within a predetermined period of time.

In this manner, a user may submit response data to the quiz test by performing a predetermined user input on the first reference quiz set.

In addition, in an embodiment, the application 111 may determine whether the submitted response data is correct (S311).

In addition, the application 111 may determine at least one attribute among acquisition, acquisition quantity, and grade data of a digital item to be issued to a user based on whether the submitted response data is correct (or, score), and may randomly select a digital item corresponding to the determined attribute and issue the same to the user.

In this connection, in an embodiment, when there are the plurality of pieces of reference quiz data set as the quiz test and thus a plurality of pieces of submitted response data, the application 111 may determine whether the answer is correct and calculate the total score by adding up the scores preset for each piece of reference quiz data.

Next, in an embodiment, the application 111 may provide the digital item selected in stage S301 when a user answers correctly. (S313-1) When the user fails to guess the correct answer, the digital item may not be provided. (S313-2) In addition, in an embodiment, the application 111 may provide a digital item of a differential grade among the digital items of the artist selected in stage S301 according to the calculated total score when the user answers a predetermined number of reference quiz data correctly.

In order to provide digital items with differential grades based on the calculated total score, in an embodiment, the application 111 may preset a predetermined total score criterion.

For example, in an embodiment, the application 111 may provide a digital item of a selected grade when the calculated total score is 100 points.

In addition, when the calculated total score is 80 or more but less than 100, a digital item one grade lower than the selected grade may be randomly provided.

In addition, when the calculated total score is 60 or more but less than 80, a digital item two grades lower than the selected grade may be randomly provided.

In cases where there are no digital items one grade lower and/or two grades lower (for example, when the digital item selected in stage S301 is of grade C), the digital item of the lowest grade that may be issued may be randomly provided.

The randomly provided digital items may have the same matching artist, but their grades are random.

In addition, when the calculated total score is less than 60 points, a user is considered to have answered incorrectly, and the digital items issued will be discarded and no new digital items may be provided.

In addition, in an embodiment, the application 111 determines the number of digital items of a differential grade to be provided among the digital items of the artist selected in stage S301 according to the calculated total score when a user answers a predetermined number of reference quiz data correctly, and issues the determined number of digital items to be provided.

In addition, in stage S309, when the first reference quiz data of the highest difficulty level (for example, top 0.1%) is set and a user answers correctly through stages S311 and S313-1 to acquire the item of the highest grade, in an embodiment, the application 111 may delete or modify the first reference quiz data from the question bank database 240 so that the first reference quiz data is no longer set.

In contrast, when a user fails to answer the first reference quiz data of the highest difficulty level, the first reference quiz data may not be deleted from the question bank database 240 but may be kept as is so as to be re-set in the quiz test.

This may be to reduce the possibility of easily providing digital items of the highest grade and maintain the quiz quality of reference quiz data corresponding to the highest difficulty level.

Through the stages described above, the application 111 according to an embodiment of the present disclosure may provide a digital item with the attributes that a user wants to acquire.

In addition, in an embodiment, the application 111 may adjust the difficulty level of the reference quiz data by comparing an issuing rate by digital item grade data of at least one piece of reference quiz data that has passed the quiz test and an acquisition rate by grade data of the preset digital item.

In addition, in an embodiment, the application 111 may adjust the issuing rate of digital items by adjusting the amount of digital items to be issued by grade through the difficulty level tuning.

To this end, in an embodiment, the application 111 may identify the number of digital items issued to users by grade.

In addition, in an embodiment, the application 111 may change the difficulty level matching the corresponding grade based on the number identified according to the criterion preset for each grade.

In detail, in an embodiment, the application 111 may adjust the solved quantity by increasing the difficulty level matching the corresponding grade to make it difficult for a user to acquire the digital item when the identified number exceeds a preset criterion of a first grade.

For example, assuming that the preset criterion for grade S is 100, when there are more than 100 grade S digital items issued to a user, the application 111 in an embodiment may increase the difficulty level class matching grade S to prepare for the risk of the rarity of grade S decreasing.

In addition, in an embodiment, the application 111 may adjust the solved quantity by increasing the number of set questions of at least one piece of reference quiz data belonging to the corresponding grade, thereby making it difficult for a user to acquire digital items, when the identified number exceeds the preset criterion of the first grade.

For example, under the same example, in an embodiment, the application 111 may increase the number of questions with grade G set when a user participates in a quiz test to acquire a digital item with grade S from three to five.

In other words, in an embodiment, the application 111 may adjust the difficulty level of reference quiz data set in a quiz test upward by changing the difficulty level class matching the first grade based on the identified number or increasing the number of set questions of at least one piece of reference quiz data belonging to the first grade, thereby lowering the probability of a user acquiring a digital item and adjusting the quantity by grade.

In addition, in an embodiment, the application 111 may tune the difficulty level by changing predetermined data included in at least one piece of reference quiz data based on the digital item issuing rate.

To this end, in an embodiment, the application 111 may modify and set the reference quiz data when the digital item issuing rate exceeds an acquisition rate criterion of the preset digital item grade.

In other words, in the reference quiz data, the question part has a content area for adjusting the difficulty level. When difficulty level adjustment is necessary, the established content area of the reference quiz data may be changed to raise/lower the difficulty level.

In detail, in an embodiment, the application 111 may tune the difficulty level of the first reference quiz data by changing the exposure range of artist information data included in the first reference quiz data where the issuing rate of the digital item exceeds a preset criterion.

For example, the application 111 may reduce the exposure range of images and videos of artist A included in the first reference quiz data, or reduce the playback time of voices and sound sources to increase the difficulty level of the first reference quiz data. As such, the difficulty level of the first reference quiz data may be lowered by increasing the exposure range of the images and videos or by increasing the playback time of the voices and sound sources.

In addition, in an embodiment, the application 111 may tune the difficulty level of the first reference quiz data by changing the answer type included in the first reference quiz data where the issuing rate of the digital item exceeds the acquisition rate for each digital item grade preset.

For example, the application 111 may change the answer type included in the first reference quiz data from multiple choice to subjective question, or increase the number of choices in the multiple choice to increase the difficulty level of the first reference quiz data. As such, the difficulty level of the first reference quiz data may be lowered by changing the answer type from subjective question to multiple choice or by reducing the number of objective questions.

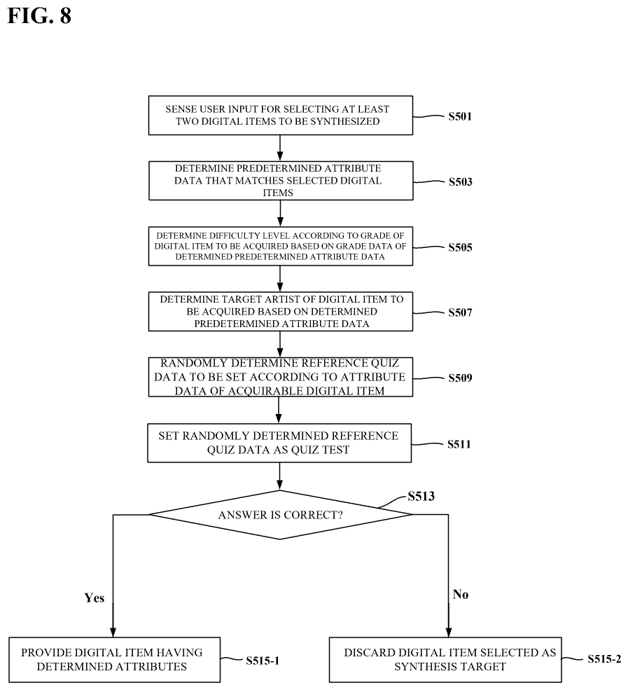

Referring to FIG. 8 to explain a method for increasing a grade matching a digital item held in a synthesis method, in an embodiment, the application 111 may sense a user input for selecting at least two digital items to be synthesized (S501).

In detail, in an embodiment, the application 111 may sense a user input for selecting at least two digital items that a user wishes to synthesize from among digital items owned by the user.

Herein, the synthesis method may be a method that provides a function to acquire digital items with upgraded grades with fewer digital items than the paid digital items by requesting synthesis by paying for at least two or more of the digital items owned by a user and then passing a quiz test. In this connection, the user performing the user input for selecting the digital item to be synthesized in an embodiment may be a user who has purchased a voucher that allows synthesis between digital items.

In addition, in an embodiment, predetermined conditions may be applied when at least two digital items to be synthesized are selected.

In detail, in an embodiment, the application 111 may apply a condition that at least one attribute between a plurality of digital items to be synthesized needs to match.

For example, in an embodiment, the application 111 may allow a plurality of digital items input during synthesis to be of the same artist or/and artist group.

In addition, in an embodiment, the application 111 may allow the plurality of digital items input during synthesis to be of the same grade.

To this end, in an embodiment, when a first digital item is input for the first time, the application 111 may detect a second digital item having attributes matching the attributes of the first digital item among the plurality of digital items owned by ae user, and activate and display the detected second digital item.

For example, conditions may be established, such as requiring that at least two digital items have the same grade, or limiting the number of digital items to be synthesized to a maximum of n. In this connection, even when 10 digital items of the same grade are selected as synthesis targets, only 1 digital item may be provided as a synthesis result.

In an embodiment, the application 111 may perform predetermined stages described below to determine whether the synthesis of the selected digital item is successful.

Next, in an embodiment, the application 111 may determine predetermined attribute data that matches the selected digital item (S503).

In detail, in an embodiment, the application 111 may determine predetermined attribute data (in an embodiment, the personal name, the group name, the gender, the agency, and the rank of an artist) of a digital item to be acquired based on a synthesis result to match the at least two or more digital items based on the at least two or more digital items selected.

For example, when a user selects a digital item (grade S) of artist B belonging to girl group A and a digital item (grade S) of artist C belonging to girl group A in stage S503, the application 111 in an embodiment may determine data such as “group A,” “female,” “artist B,” “artist C,” and “grade S.” To this end, in an embodiment, the application 111 may detect a predetermined reference quiz data among at least one piece of reference quiz data stored in the question bank database 240 according to the determined attribute item data.

Next, in an embodiment, the application 111 may determine the difficulty level according to the grade of the digital item to be acquired based on the grade data among the determined predetermined attribute data (S505).

To this end, in an embodiment, the application 111 may determine the grade of a digital item to be acquired through synthesis based on grade data among the determined predetermined attribute data.

In detail, in an embodiment, the application 111 may determine the grade of an acquirable digital item from among a grade that is at least equal to the extracted grade data and/or a grade that is higher than the extracted grade data.

In addition, in another embodiment, the application 111 may determine the grade of the digital item to be acquired upon successful synthesis based on a user input from the user selecting the grade. In this connection, the application 111 may provide a selection from among grades that are equal to or higher than the extracted grade data.

Once the grade of an acquirable digital item is determined, in an embodiment, the application 111 may determine the difficulty level of reference quiz data to be set in the quiz test based on the determined grade.

In this connection, in an embodiment, the application 111 may determine the difficulty level of reference quiz data to be set in the quiz test to be higher as the determined grade is higher.

In addition, in an embodiment, the application 111 may establish a predetermined setting range for each grade in order to determine the difficulty level of the reference quiz data based on the determined grade.

The description of the method for setting the question range is the same as the stage S305 described above, and thus may be applied. In the same way, the application 111 in an embodiment may determine the difficulty level of reference quiz data to be set in the quiz test based on a predetermined criterion matched to the determined grade. Herein, the predetermined criterion may mean the probability of acquiring a digital item due to successful synthesis, or in another sense, may mean the probability of successfully synthesizing the digital item to be acquired.

Next, in an embodiment, the application 111 may determine the target artist of the digital item to be acquired based on the determined predetermined attribute data (S507).

In detail, in an embodiment, the application 111 may determine the target artist of the digital item to be acquired when synthesis is successful based on the determined predetermined attribute data (in an embodiment, at least one piece of data of the individual activity name, the group name, the gender, and the agency data of an artist).

In this connection, when the artist personal name data among the predetermined attribute data of each of the plurality of digital items matches, the application 111 in an embodiment may determine the target artist of the acquirable digital item as the artist.

For example, when artist individual activity name data among the predetermined attribute data determined for each of a plurality of digital items includes “Artist A,” in an embodiment, the application 111 may determine the target artist of the acquirable digital item as “artist A.” In addition, when the artist individual name data among the attribute data of the plurality of digital items are different but artist group name data matches, in an embodiment, the application 111 may determine the target artist of the acquirable digital item as the artist group.

For example, when the artist individual name data among the determined predetermined attribute data is “artist A” and “artist B” but the artist group name data is “group C,” in an embodiment, the application 111 may determine the target artist group of the acquirable digital item as “group C.” In this connection, when the target of the acquirable digital item is a group rather than an individual artist, the reference quiz data described below may be a quiz about the group, and the digital item provided upon successful synthesis may also be a digital item about the group.

In addition, when none of the determined predetermined attribute data matches, in an embodiment, the application 111 may determine the target artist of the acquirable digital item as at least one of the extracted first and second artist individual activity names or the first and second artist group names.

For example, when the input first digital item has the artist individual activity name data as “artist A” and the artist group name data as “group C,” and the input second digital item has the artist individual activity name data as “artist B” and the artist group name data as “group D,” the application 111 may determine the target artist of the acquirable digital item as at least one of the individual “artist A,” the individual “artist B,” the individual “group C,” or the individual “group D.” Next, in an embodiment, the application 111 may determine the attributes of reference quiz data to be set based on the attribute data of digital items acquirable through synthesis (S509).

In detail, in an embodiment, the application 111 may determine the attributes (in an embodiment, the level of difficulty and the target artist) of the reference quiz data to be set based on the grade data of the obtainable digital item and the target artist.

In addition, in an embodiment, the application 111 may detect reference quiz data matching the target artist of the acquirable digital item from the question bank database (240).

For example, in an embodiment, when the acquirable digital item is an “artist A” of “grade SS,” the application 111 may determine an attribute including a difficulty level that has a correct answer rate of 0% to 0.1% that matches the grade SS related to the “A artist” and detect corresponding reference quiz data from the question bank database 240.

The description of the process for determining reference quiz data to be set according to a synthesis request is the same as the process for determining reference quiz data in a draw, so any redundant description will be omitted.

In addition, the application 111 may randomly determine quiz data to be set from a plurality of pieces of detected reference quiz data.

In detail, in an embodiment, the application 111 may determine at least one piece of reference quiz data randomly selected from among the plurality of pieces of reference quiz data having a difficulty level determined for an acquirable digital item and an attribute corresponding to a target artist as a quiz test for a synthesis request.

Next, in an embodiment, the application 111 may set randomly determined first reference quiz data as a quiz test (S511).

A detailed explanation of this is identical to the content of S309 described above, and thus is omitted by applying the content.

In addition, in an embodiment, the application 111 may determine whether the submitted response data is correct (S513).

In this connection, in an embodiment, when there are the plurality of pieces of reference quiz data set as quiz tests and thus a plurality of pieces of submitted response data, the application 111 may determine whether the answer is correct and calculate a total score by adding up the scores preset for each piece of reference quiz data.

Next, in an embodiment, the application 111 may provide one of the digital items having the grade determined in stage S505 and the attributes of the target artist determined in stage S507 when a user answers correctly (S515-1).

In other words, in an embodiment, the application 111 may provide one digital item having a higher grade than the grades of at least two digital items selected as synthetic materials in stage S501 when a user answers the reference quiz data set in the quiz test correctly.

In an embodiment, the digital item provided upon successful synthesis may have a higher price information contained in the NFT smart contract data than the digital item prior to synthesis.

In addition, in an embodiment, the application 111 may additionally reinforce and upgrade the digital item provided upon successful synthesis, thereby adding predetermined content to the NFT media data included in the digital item, or improving the quality of conventional content to increase rarity value, thereby further increasing the price information included in the NFT smart contract data.

In an embodiment, the application 111 may provide a digital item of a differential grade according to the calculated total score when a user answers only a predetermined number of reference quiz data correctly.

In order to provide digital items with differential grades based on the calculated total score, in an embodiment, the application 111 may preset a predetermined total score criterion.

For example, in an embodiment, the application 111 may provide a digital item having a matched grade higher than the grades of at least two digital items selected as synthetic materials when the calculated total score is 100 points.

In addition, when the calculated total score is 80 points or more but less than 100 points, a digital item with the same grade as at least two digital items selected as synthetic materials may be randomly provided.

In addition, when the calculated total score is 60 or more but less than 80 points, a digital item that is one grade lower than the grade of at least two digital items selected as synthetic materials may be randomly provided.

When there is no digital item of the lower grade above (for example, when at least two digital items selected as synthetic materials are of grade C), the digital item of the lowest grade that may be paid may be provided randomly.

The randomly provided digital items may have the same matching artist, but their grades are random.

In addition, when the calculated total score is less than 60 points, a user is considered to have failed to guess the correct answer, and at least two digital items paid for will be discarded, and high-grade digital items resulting from successful synthesis may not be provided.

In contrast, when a user fails to guess the correct answer, the application 111 may discard at least two digital items selected for synthesis in stage S501 (S515-2).

In such a case, the application 111 in an embodiment may maintain the rarity of digital items including a predetermined grade through discard when an excessive quantity of a predetermined grade is provided to users.

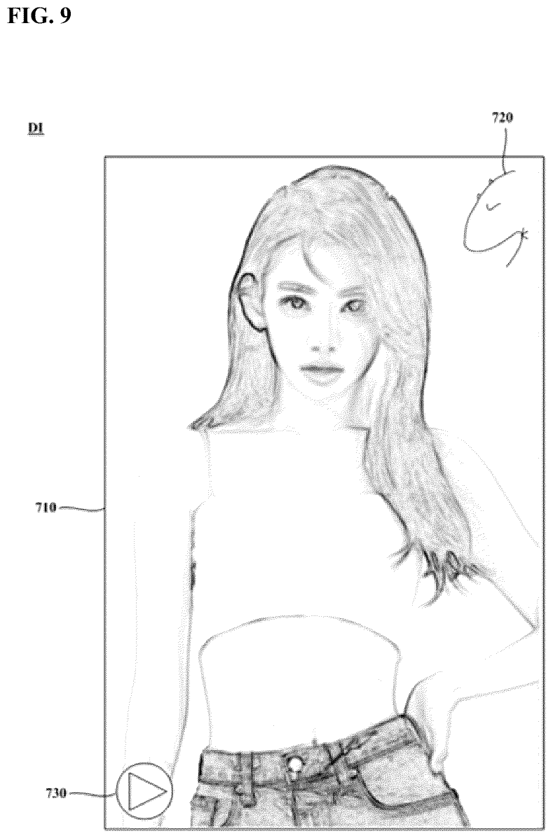

FIG. 9 is an example of a digital item provided according to an embodiment of the present disclosure.

Referring to FIG. 9, a digital item (DI) may include at least one content among an artist image 710, a text 720, and auditory 730.

In an embodiment, the digital item (DI) may include an artist image 710 as main content and at least one of the text 720 or the auditory 730 as sub-content. In detail, in an embodiment, the first digital item may include one main content and at least one sub-content.

In an embodiment, the artist image 710 included in the digital item (DI) may be an image of an individual artist and/or a group of artists that represent the appearance of the artist, for example, a photo, video, or drawing (for example, a caricature) of the artist.

In addition, in an embodiment, the text 720 may be numbers and letters that are displayed overlaid on the artist image 710. For example, the text 720 may include an album name of an artist, the name of an individual artist and/or group, and an anniversary. In addition, the text 720 may include an image of text handwritten by an artist.

In addition, in an embodiment, the text 720 may be configured of a font specified by a user and/or an administrator, or a font containing the actual handwriting of an artist.

In addition, in an embodiment, the auditory 730 may mean content output as audio when a user inputs an affordance for selecting whether to output the auditory on the artist image 710. For example, the auditory 730 may include a portion of a sound source of an artist and a voice message consisting of the voice of the artist.

### Digital Item

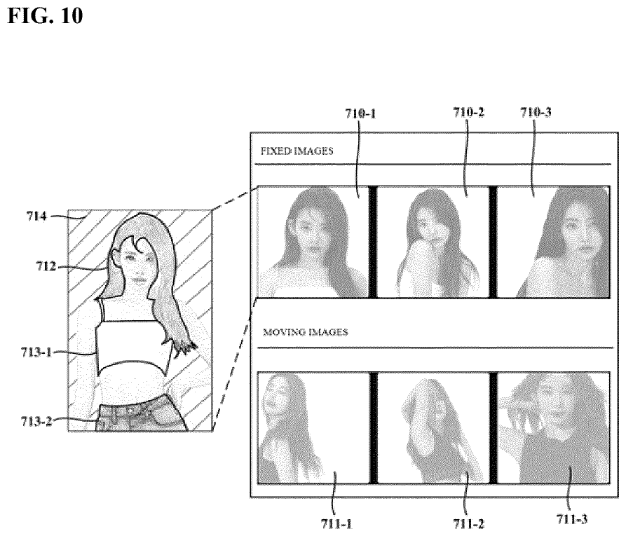

The application 111 according to an embodiment may provide a user interface (UI) for selecting main content and sub-content to configure the digital item (DI) in order to create the digital item (DI). FIG. 10 is an example of a UI for selecting main content of a digital item according to an embodiment of the present disclosure. In other words, the application 111 according to an embodiment may upgrade the grade of the digital item (DI) by answering a quiz and through reinforcement or synthesis, and may provide the UI for creating an upgraded digital item (DI) by modifying such upgrade according to the taste of a user.

Referring to FIG. 10, in an embodiment, the application 111 may sense selection of the artist image 710 to be used as the main content of the digital item (DI) based on the UI.

In detail, in an embodiment, the application 111 may provide at least one fixed image 710-1 to 710-3 and/or a moving image 711-1 to 711-3.

Accordingly, in an embodiment, the application 111 may sense selection of the artist image 710 to be used as the main content of the digital item (DI) based on a user input.

In addition, in an embodiment, the application 111 may change the attributes of a predetermined area configuring the fixed image when a user selects the fixed image based on the UI.

The predetermined area may include a first area 712 including the hair of an artist, a second area 713-1 and 713-2 including the clothing of the artist, and a third area 714 including the background of an artist image.

The second areas 713-1 and 713-2 may exist in plural in numbers depending on the clothing (for example, tops, bottoms, one-piece dresses, and shoes) and accessories (for example, hats and bags) worn by an artist, and the number thereof is not limited to that illustrated.

In one embodiment, the application 111 may change the attributes of the artist image 710 by changing the color and style of the first area 712 and the second area 713-1 and 713-2 based on a user input.

In addition, the attributes of the artist image 710 may be changed by changing the color and pattern of the third area 714.

In addition, in an embodiment, the application 111 may provide the UI for selecting sub-content to be added to the selected artist image 710 after selecting the artist image 710 to be used as the main content of the digital item (DI) as described above.

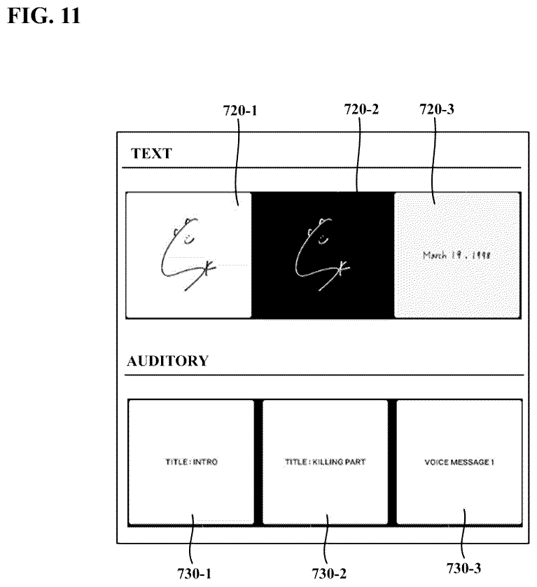

FIG. 11 is an example of a UI for selecting sub-content of a digital item according to an embodiment of the present disclosure.

Referring to FIG. 11, in an embodiment, an application 111 may sense selection of at least one text 720 and auditory 730 to be used as sub-content of the digital item (DI) based on the UI.

In detail, in an embodiment, the application 111 may provide at least one text 720-1 to 720-3 and/or auditory 730-1 to 730-3.

Accordingly, in an embodiment, the application 111 may sense selection of at least one text 720 and auditory 730 to be used as sub-content of the digital item (DI) based on a user input.

In addition, in an embodiment, the application 111 may change the attribute by adding the number of texts 720 to be included in the sub-content or adding a predetermined effect to the text 720.

In addition, in an embodiment, the application 111 may change the attribute by extending the playback time of the auditory 730 included in the sub-content.

In other words, in an embodiment, the application 111 may provide the UI for selecting main content and sub-content of the digital item (DI), whereby a user may select at least one fixed image and/or moving image, determine the main content by changing the attributes of a predetermined area constituting the selected image, and determine the sub-content by adding at least one text 720 and auditory 730 output on the main content, thereby customizing the artist image 710 according to the user input.

Next, the service server 200 according to an embodiment may generate a plurality of unique digital items (DI) formed by a combination of at least one text 720 and an auditory 730 output on the artist image 710 customized based on the application 111.

In other words, the plurality of digital items (DI) may be unique digital items (DI) with numerous combinations of artist images 710 included in the main content, attributes of a predetermined area configuring the artist image 710, texts 720 included in the sub-content, and the number/type/attributes of the auditory 730 all being different.

In addition, in an embodiment, the service server 200 may register each of these plurality of digital items (DI) as NFTs.

In detail, in an embodiment, the service server 200 may register the plurality of digital items (DI) as a unique NFT by adding NFT metadata including description information, creator information, and storage address information, and NFT smart contract data including owner information, transaction history information, condition information, and price information, using blockchain technology.

In addition, in an embodiment, the service server 200 may provide the plurality of digital items (DI) registered as the NFT to a user as NFT-based digital items, and may improve the grade of the provided NFT-based digital items through synthesis and reinforcement performed in the application 111. In this connection, as the grade of the NFT-based digital item improves, the price information included in the NFT smart contract data also improves, which may increase the asset value of the digital item.

To this end, in an embodiment, the service server 200 may determine the grade of each NFT-based digital item based on the main content and sub-content included in the NFT-based digital item.

In this connection, elements determining the grade may include the resolution and video playback length of the artist image 710 included in the main content of the NFT-based digital item, the number of texts 720 included in the sub-content, and the sound quality and audio playback length of the attributes and auditory 730.

In other words, the elements determining the grade may include a first element for the resolution of the main content, a second element for the video playback length of the main content, a third element for the number of texts 720 of the sub-content, a fourth element for the attributes of the texts 720 of the sub-content, a fifth element for the sound quality of the audio 730 of the sub-content, and a sixth element for the audio playback length of the auditory 730 of the sub-content.

In an embodiment, the service server 200 may provide an NFT digital item of a higher grade than the paid NFT digital item by increasing the level of the first to sixth elements included in the NFT digital item paid for by a user for reinforcement and synthesis according to the success of reinforcement and synthesis.

To this end, in an embodiment, the service server 200 may established predetermined detailed stags (for example, first to tenth stages) for each of the first to sixth elements.

In this connection, the detailed stages may be such that the first stage may be the attribute with the lowest quality/quantity, and the tenth stage may be the attribute with the highest quality/quantity. In addition, the first stage may be a stage designated as default.

In detail, in an embodiment, the service server 200 may establish the first stage with the lowest resolution to the tenth stage with the highest resolution in the first element for the resolution of the main content.

In addition, in an embodiment, the service server 200 may establish the case where the artist image 710 included in the main content is a fixed image that does not move as the first stage in the second element for the video playback length of the main content, and may establish the second stage with the shortest video playback length to the tenth stage with the longest video playback length.

In addition, in an embodiment, the service server 200 may establish the first stage with 0 texts 720 to the tenth stage with 10 texts 720 in the third element for the number of texts 720 of the sub-content.

In addition, in an embodiment, the service server 200 may establish the first stage in which O attributes are added to the text 720 in the fourth element for the attributes of the text 720 of the sub-content to the tenth stage in which 10 attributes are added to the text 720. In this connection, attributes added to the text 720 may include font upgrades, font size upgrades, and addition of effects (for example, sparkles and movements).

In addition, in an embodiment, the service server 200 may establish the fifth element of the sound quality of the auditory 730 of the sub-content from the first stage with the lowest sound quality to the tenth stage with the highest sound quality.

In addition, in an embodiment, the service server 200 may establish, in the sixth element for the audio playback length of the auditory 730 of the sub-content, the first stage having the shortest audio playback length to the tenth stage having the longest audio playback length of the auditory 730.

In other words, in an embodiment, the service server 200 may determine a higher grade of the NFT digital item as getting closer to the tenth stage, in which the resolution of the main content included in the NFT-based digital item is the highest, the video playback length is the longest, the number of texts in the sub-content is the largest, the number of attributes added to the text is the largest, the sound quality of the auditory of the sub-content is the highest, and the audio playback length is the longest.

In addition, in an embodiment, when reinforcement is successful, the service server 200 may increase the stage of at least one element among the stages of the first to sixth elements included in the NFT digital item paid by a user for reinforcement by a predetermined stage (for example, one stage and/or more than one stage).

In addition, in an embodiment, when synthesis is successful, the service server 200 may increase the stage of at least one element among the stages of the first to sixth elements included in at least two NFT digital items paid by a user for synthesis by a predetermined stage (for example, one stage and/or more than one stage). In this connection, the stages of each of the first to sixth elements included in at least two NFT digital items paid for synthesis may be the same, and thus the grade may also be the same.

In this connection, in an embodiment, the service server 200 may randomly determine at least one element among the first to sixth elements whose stages are increased according to the success of the reinforcement and synthesis, or may determine the element based on a selection input of a user using the application 111.

In this way, in other words, in an embodiment, the service server 200 may sense an input for paying at least one NFT digital item owned by a user for reinforcement and/or synthesis, execute a quiz test with differential difficulty level according to the grade of the at least one NFT digital item paid, and when the result of the executed quiz test satisfies a predetermined condition, provide the NFT digital item of a higher grade than the at least one NFT digital item paid.

For example, in an embodiment, the service server 200 may provide a digital item of a higher grade than the paid digital item by providing the first digital item with the resolution of the second stage when a user pays for n digital items with the resolution of the first stage as synthesis materials and succeeds in synthesis by passing a quiz test.

In other words, in an embodiment, the service server 200 may provide a digital item of a higher grade than the grade matched to the digital item paid for the synthesis and reinforcement through synthesis and reinforcement between digital items by increasing the detailed stages for each element that determines the grade.

For example, in an embodiment, the service server 200 may increase the resolution of the main content included in the paid digital item or provide a digital item with a longer video playback length depending on the success of reinforcement and synthesis.

In addition, in an embodiment, the service server 200 may provide a digital item with the number and attributes of text 720 added to the sub-content included in the paid digital item according to the success of reinforcement and synthesis.

In addition, in an embodiment, the service server 200 may provide a digital item with a longer audio playback length of the auditory 730 among the sub-content included in the paid digital item according to the success of reinforcement and synthesis.

In an embodiment, the service server 200 may provide a function to upgrade a digital item by modifying the artist image 710, which is the main content of the digital item, through a generative artificial intelligence model according to the tastes of a user.

To this end, the service server 200 may include a generative artificial intelligence model that generates an artist image 710 of a digital item based on the text or sketch of a user.

These generative artificial intelligence models may be models that additionally learn the images of an artist in addition to conventional generative artificial intelligence models such as stable diffusion, and in which a plurality of styles of digital items are additionally trained.

In other words, the generative artificial intelligence model may precisely create an artist image based on the artist of the digital item by additionally learning the plurality of images of each artist.

In addition, the generative artificial intelligence model may additionally learn the style of the artist image for each digital item of the artist.

For example, the generative artificial intelligence model may be trained by designating the first digital items issued for artist A upon the release of album B as style K, and the second digital items issued for artist A upon performance B as style L.

In other words, the generative artificial intelligence model may create an artist image of an underlying digital item that is to be reinforced/synthesized, and an upgraded artist image that matches the style of the digital item.

In more detail, when a user wants to create a new artist image 710 of a digital item through reinforcement/synthesis, the user may first select a function to change the artist image 710 through the application 111.

In addition, when a user changes the artist image through the application 111, the user may induce the modification of the artist image by attaching text, sketch images, or/and photos in the desired direction.

For example, a user may input his or her own photo into the application 111 and input a request in text such as “Create an image of the person in the photo and the artist performing action A (for example, shaking hands).” The service server 200 that receives such input may input photos and text into the generative artificial intelligence model to create an image matching the request of a user.

In this connection, the service server 200 may maintain the artist attribute of the digital item by providing an additional input to the generative artificial intelligence model to create the artist limited to the artist of the underlying digital item used for synthesis/reinforcement.

In addition, the service server 200 may maintain the style of the digital item by providing additional input to create an artist image in the style of the underlying digital item used for synthesizing/reinforcing the artist.

Through this generative artificial intelligence model, users may create their own digital content, which is the main need for NFT digital items, in the direction the users want. In this connection, by maintaining the artist or style attributes of the digital item, the direction of digital item issuance by the artist or agency may be prevented from being changed indiscriminately by the users.

Hereinbefore, the method and system for providing the NFT-based digital items according to an embodiment of the present disclosure can prevent illegal copying and distribution of counterfeit products impersonating IP by digitally assetizing artist IP-based content products.

In addition, the method and system for providing the NFT-based digital items according to an embodiment of the present disclosure can exclude the possibility of probability manipulation by setting a quiz about an artist and issuing digital items according to the quiz results.

In addition, the method and system for providing the NFT-based digital items according to an embodiment of the present disclosure can reduce gambling by setting a quiz with a differential difficulty level according to a grade of the digital items and adjusting the success probability of drawing/reinforcement/synthesis.

In addition, the method and system for providing the NFT-based digital items according to an embodiment of the present disclosure can manage the difficulty level based on the success rate of acquiring the digital items according to the quiz setting, thereby applying a reasonable difficulty level to the grade of the digital items and maintaining the rarity of the corresponding digital items.

In addition, the method and system for providing the NFT-based digital items according to an embodiment of the present disclosure can improve satisfaction of fans and induce high participation of fans by issuing the digital items reflecting the tastes of fans.

The embodiments of the present disclosure described above may be implemented in the form of program commands which may be executed through various types of computer constituting elements and recorded in a computer-readable recording medium. The computer-readable recording medium may include program commands, data files, and data structures separately or in combination thereof. The program commands recorded in the computer-readable recording medium may be those designed and configured specifically for the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; and hardware devices specially designed to store and execute program commands such as ROM, RAM, and flash memory. Examples of program commands include not only machine codes such as those generated by a compiler but also high-level language codes which may be executed by a computer through an interpreter and the like. The hardware device may be replaced with by one or more software modules to perform the operations of the present disclosure, and vice versa.

### INDUSTRIAL APPLICABILITY

An embodiment of the present disclosure provides a reinforcement or synthesis function for modifying an NFT digital item to reflect the taste of a user through a service server and an application, and includes a series of processes for providing a process for managing the modified digital item as an NFT through a blockchain network, and thus has industrial applicability.

What is claimed is:

1. A method for providing non-fungible token (NFT)-based digital items by which a user terminal executed through at least one processor of the user terminal provides the NFT-based digital items, the method comprising:
inputting a plurality of digital items owned by a user, and executing synthesis to acquire at least one new digital item;
determining grade data and a target artist of the new digital item based on the plurality of input digital items;
determining, based on the determined grade data, a difficulty level of reference quiz data to be set as a quiz test;
determining, based on the determined target artist, a target artist of the reference quiz data to be set as the quiz test;
setting, as a quiz test, first reference quiz data corresponding to the determined difficulty level and the target artist; and
determining, based on response data submitted for the quiz test, whether to acquire the new digital item and a grade thereof.

2. The method of claim 1, wherein the digital item is an NFT in which digital data of digital content comprising artist-related content is registered on a blockchain.

3. The method of claim 2, wherein the digital data of the digital item comprises NFT media data, NFT metadata, and NFT smart contract data, wherein:
the NFT media data comprises main content comprising an artist image, and sub-content comprising at least one of an artist-related text or auditory;
the NFT metadata comprises at least one or more of description information, creator information, or storage address information for the digital item; and
the NFT smart contract data comprises at least one or more of owner information, transaction history information, condition information, or price information for the digital item.

4. The method of claim 1, wherein the reference quiz data comprises at least one of the following data: artist name, artist group name, artist information data, question creation date, question type, question data, answer type, answer data, correct answer rate, difficulty level, and digital item issuance rate.

5. The method of claim 4, further comprising constructing a question bank database comprising at least one piece of reference quiz data in a server providing the synthesis.

6. The method of claim 5, wherein the construction of the question bank database comprises:
conducting a mock test for a plurality of users based on a plurality of pieces of new quiz data;
calculating a correct answer rate for each of the plurality of pieces of new quiz data based on results of the mock test for the plurality of users and determining the difficulty level based on the calculated correct answer rate;
including the new quiz data for which the difficulty level has been determined as the reference quiz data in the question bank database; and
providing a reward to the plurality of users who have conducted the mock test.

7. The method of claim 1, wherein the determination of the grade data and target artist of the new digital item based on the plurality of input digital items comprises:
extracting at least one or more pieces of data among a personal name of a first artist, a group name to which the first artist belongs, a gender of the first artist, and a first grade that match a first digital item of the plurality of input digital items;
extracting at least one or more pieces of data among a personal name of a second artist, a group name to which the second artist belongs, a gender of the second artist, and a second grade that match a second digital item of the plurality of input digital items; and
determining an artist or artist group that matches the data extracted from the first digital item and the second digital item as the target artist.

8. The method of claim 1, wherein the determination, based on the determined grade data, of the difficulty level of the reference quiz data to be set as the quiz test comprises:
establishing a synthesis success rate of the new digital item of the grade data of a predetermined level through the synthesis;
determining a correct answer rate corresponding to the established synthesis success rate as the difficulty level; and
establishing at least one piece of reference quiz data included in the determined difficulty level as a setting range.

9. The method of claim 1, wherein the determination, based on the determined target artist, the target artist of the reference quiz data to be set as the quiz test comprises:
determining an individual artist as the target artist when individual names of first and second artists are the same;
determining a group to which the artist belongs as the target artist when the individual names of the first and second artists are different but group names to which the first and second artists belong are the same; and
determining one of first and second individual artists as the target artist when the individual names of the first and second artists and the group names to which the first and second artists belong are different but genders of the first and second artists are the same.

10. The method of claim 1, wherein the setting, as the quiz test, of the first reference quiz data corresponding to the determined difficulty level and the target artist comprises: randomly determining the first reference quiz data included in a setting range from among all pieces of reference quiz data for the determined target artist stored in a question bank database.

11. The method of claim 1, further comprising deleting the first reference quiz data from a question bank database after the quiz test is set and a user answers correctly, and a digital item is issued to the user when the first reference quiz data is of the highest difficulty level included within a predetermined setting range.

12. A system for providing NFT-based digital items, the system comprising:
at least one display that outputs digital item content;
at least one memory; and
at least one processor,
wherein at least one application that is stored in the memory and executed by the processor to provide the NFT-based digital items:
input a plurality of digital items owned by a user, and execute synthesis to acquire at least one new digital item;
determine grade data and a target artist of the new digital item based on the plurality of input digital items;
determine, based on the determined grade data, a difficulty level of reference quiz data to be set as a quiz test;
determine, based on the determined target artist, a target artist of the reference quiz data to be set as the quiz test;
set, as a quiz test, first reference quiz data corresponding to the determined difficulty level and the target artist; and
determine, based on response data submitted for the quiz test, whether to acquire the new digital item and a grade thereof.
